(19) United States
(12) Patent Application Publication
(10) Pub. No.: US 2026/0349424 A1
(43) Pub. Date: Nov. 5, 2026

(54) METHOD, SYSTEM AND PROGRAM FOR PARTS MANAGEMENT

(71) Applicant: DENSO CORPORATION, Kariya-city (JP)

(72) Inventors: Yumi MARUYAMA, Kariya-city (JP); Kazuaki MAWATARI, Kariya-city (JP)

(21) Appl. No.: 19/716,615

(22) Filed: Jun. 23, 2026

Related U.S. Application Data
(63) Continuation of application No. PCT/JP2024/038091, filed on Oct. 25, 2024.

(30) Foreign Application Priority Data
Dec. 25, 2023 (JP) 2023-218344

(51) Int. Cl. G05B 23/02

(52) U.S. Cl. CPC G05B 23/0272; G05B 23/0283

(57) ABSTRACT

A parts management system includes a sensor that detects condition of a consumable part in the facility. The system includes a control device that determines replace support information including a remaining count and a replacement time for the consumable part based on the condition of the consumable part. Further, the system includes an output device that outputs replace support information. The output device includes a display device that outputs replace support information to a worker. The output device includes a communication device for providing replace support information to entities that make up a supply chain.

### CROSS REFERENCE TO RELATED APPLICATION

The present application is a continuation application of International Patent Application No. PCT/JP 2024/038091 filed on Oct. 25, 2024, which designated the U.S. and is based on Japanese Patent Application No. 2023-218344, filed on Dec. 25, 2023, the entire contents of which are incorporated herein by reference.

### TECHNICAL FIELD

The disclosures in this specification relate to methods, systems, and programs for managing interchangeable parts.

### BACKGROUND

In facilities using consumable parts, when a consumable part reaches a specific number of use count workers perform a replacement work to replace a used one of the consumable part to a new one of the consumable part. Workers have to perform the replacement work efficiently and have to plan a plurality of the replacement works for a plurality of consumable parts in the facility. From the perspectives mentioned above, or from other perspectives not mentioned here, further improvements are needed in methods, systems, and programs for parts management.

A system disclosed in this specification provides a part management system. The system comprising: a consumable part installed in a facility that is subject to wear; a sensor that detects a physical quantity that change in relation to wear of the consumable part; a control device configured to generate replace support information including a remaining count for the consumable part and a replacement time at which the consumable part is required to be replaced based on the physical quantity detected by the sensor; and a display device for displaying the replace support information.

According to the disclosed parts management system, the display shows the remaining quantity and the replacement time. As a result, workers viewing the display can plan and carry out the replacement of wear parts. As a result, it is possible to reduce the workload on workers.

A method of part management, executed by a control device comprising at least one processor, the method comprising the steps of: acquiring physical quantity that change in relation to wear from a consumable part; generating replace support information including a remaining count for the consumable part and a replacement time at which the consumable part is required to be replaced based on the physical quantity detected by the sensor; and displaying the replace support information on a display device.

A non-transitory computer-readable medium storing thereon program instructions that, when executed by a processor, cause the processor to perform a method comprising: acquiring physical quantity that change in relation to wear from a consumable part; generating replace support information including a remaining count for the consumable part and a replacement time at which the consumable part is required to be replaced based on the physical quantity detected by the sensor; and displaying the replace support information on a display device.

The disclosed aspects in this specification adopt different technical solutions from each other in order to achieve their respective objectives. Reference numerals in parentheses described in claims and this section exemplarily show corresponding relationships with parts of embodiments to be described later and are not intended to limit technical scopes. The objects, features, and advantages disclosed in this specification will become apparent by referring to following detailed descriptions and accompanying drawings.

### BRIEF DESCRIPTION OF DRAWINGS

FIG. 1 is a block diagram of a parts management system according to a first embodiment.

FIG. 2 is a block diagram showing a relationship among a supply chain and the system.

FIG. 3 is a flowchart showing a parts management method and program.

FIG. 4 is a top view showing a display on a display device.

FIG. 5 is a block diagram of a parts management system according to a second embodiment.

FIG. 6 is a plan view showing the display.

FIG. 7 is a block diagram of a parts management system according to a third embodiment.

FIG. 8 is a plan view showing the display.

FIG. 9 is a block diagram of a parts management system according to a fourth embodiment.

FIG. 10 is a flowchart according to a fifth embodiment.

FIG. 11 is a flowchart according to the fifth embodiment.

FIG. 12 is a flowchart according to a sixth embodiment.

FIG. 13 is a table showing condition of a facility and displays.

FIG. 14 is a flowchart according to a seventh embodiment.

FIG. 15 is a table showing condition of a facility and displays.

FIG. 16 is a flowchart according to an eighth embodiment.

FIG. 17 is a table showing condition of a facility and displays.

FIG. 18 is a flowchart according to a ninth embodiment.

FIG. 19 is a table showing condition of a facility and displays.

FIG. 20 is a table showing condition of a facility and displays according to a tenth embodiment.

FIG. 21 is a flowchart according to an eleventh embodiment.

FIG. 22 is a graph showing an upper limit of a use count.

FIG. 23 is a flowchart according to the eleventh embodiment.

### DETAILED DESCRIPTION

JP 2005-258585A discloses a method, system, and program for automatically ordering parts for a molding machine. The control device described in Patent Literature 1 automatically predicts when the parts of a molding machine will wear out, automatically determines when to place an order based on the predicted wear-out time, and automatically handles the ordering process. The contents of the prior art literature are incorporated herein by reference to explain technical elements in this description.

The technology described in JP 2005-258585A merely requires workers to replace parts when they reach an end of their service life, thereby increasing the worker's workload. When a plurality of parts need to be replaced, the workload on the workers increases even further. From the perspectives mentioned above, or from other perspectives not mentioned here, further improvements are needed in methods, systems, and programs for parts management.

It is an object of this disclosure to provide methods, systems, and programs for managing parts that can provide support information to facilitate efficient replacement of parts.

A plurality of embodiments are described with reference to the drawings. In some embodiments, functionally and/or structurally corresponding and/or associated elements may be given the same reference numerals, or reference numerals with different digit placed on equal to or higher than a hundred place. With respect to the parts that correspond to or are associated with each other, explanations thereof can be shared among the embodiments.

### First Embodiment

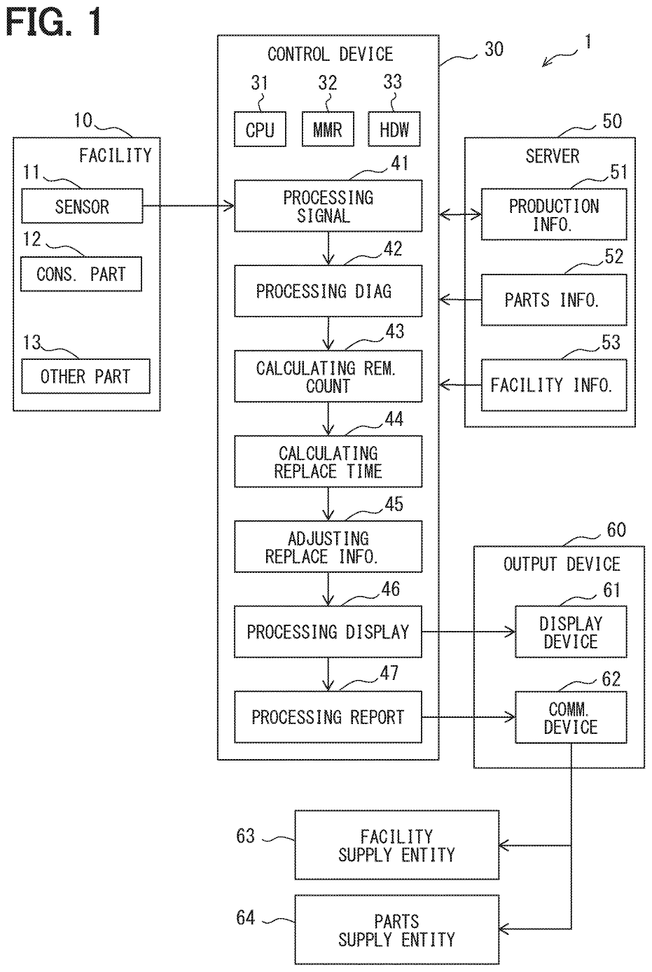

In FIG. 1, the parts management system 1 is used in a supply chain that includes manufacturing entities that manufacture products using a facility using consumable parts. In the following explanation, the term “entity” refers to a company, an organization, a group, or an individual. Therefore, the term “manufacturing entity” refers to the entity that manufactures products. The system 1 is used to implement methods. Furthermore, the system 1 is configured to perform predetermined functions by executing programs stored on a storage medium via a processing circuit. The system 1 is also a system that provides solutions for manufacturing industries. In the manufacturing industry, production planning, capacity planning, logistics planning, and/or transportation planning are subject to change due to various factors. The system 1 supports development of optimized plans within certain constraints and is used to formulate and execute optimized plans. In addition, the system 1 uses IoT technology to monitor conditions of parts and perform analyses. The system 1 may utilize AI technologies as needed. Furthermore, the system 1 provides new values to the multiple entities that make up the supply chain, including manufacturing entities. Note that AI technologies may be provided using techniques known as machine learning and/or deep learning.

In FIG. 1, the system 1 includes a facility 10. The facility 10 is, for example, a processing machine located at a manufacturing entity's factory or facility. The facility 10 may, for example, be a conveyor system located in a manufacturing entity's factory or facility. The manufacturing entity produces products by processing or transporting workpieces using the facility 10. The facility 10 includes a plurality of mechanical parts.

The plurality of mechanical parts include a consumable part 12 provided in the facility. The consumable part 12 is a part that wears out. The consumable part 12 wears out as the consumable part 12 is used. If the consumable part 12 is installed in the facility used to process workpieces, the consumable part 12 is a part that wears out as the workpieces are processed. Wear of the consumable part 12 can be tracked as a consumption amount. In an opposite view, wearing of the consumable part 12 can be recognized as remaining units for which the consumable part 12 is usable. The remaining units may be recognized as a remaining quantity. Unit of the remaining amount may be expressed in various units, such as a remaining count, a remaining distance, and a remaining time. The consumable part 12 wears out, for example, as the number of times the workpiece is processed increases. In this case, the remaining quantity of the consumable part 12 may be expressed as the remaining count.

The consumable part 12 is a mechanical component that wear out not only as a result of the machining process itself but also during related processes, such as transportation associated with machining. An example of the consumable part 12 is a cutting tool used to machine the product. The consumable part 12 may include one or more of a variety of components, such as a cutting tool, a bearing, a conveyor, a vise, or a wiper. In addition to the consumable parts 12, the facility 10 includes other parts 13. The other part 13 may refer to one or more of the numerous components other than the consumable part 12. The other part 13 may, for example, be a support device that supports the consumable part 12. The other part 13 may, for example, be a drive device such as motors that cause relative movement between the consumable part 12 and the workpiece.

The following description explains the case where the consumable part 12 is a cutting tool. It is described that the other part 13 is a holder that supports the cutting tool. Alternatively, or in addition, the other part 13 may include an electric motor that drives a relative movement between the cutting tool and the workpiece (sometimes referred to as a processed piece). In the following description, specific examples such as cutting tools, holders, and electric motors are provided for illustrative purposes only. These specific examples are not intended to limit the scope of the disclosure in this specification.

The facility 10 includes a sensor 11. The sensor 11 monitors a physical behavior of the facility that indicates condition of the consumable part 12 and detects a physical quantity that reflect this behavior. The sensor 11 detects physical quantities that change as the consumption amount on the consumable part 12 increases. The physical quantity detected by the sensor 11 is a physical quantity related to the consumption amount of the consumable part 12. The sensor 11 outputs a sensor signal indicating the detected physical quantity. Therefore, the sensor 11 detects the physical quantity that change in relation to wear of the consumable part 12. The sensor 11 can be installed at any location on the facility 10. The sensor 11 may be installed near the consumable part 12. Furthermore, the sensor 11 may be installed in a device separate from the facility 10.

The sensor 11 is provided, for example, by a sensor that detects sound, vibration, or temperature. If the sensor 11 is an acoustic sensor, the sensor 11 detects, for example, changes in sound frequency caused by an increase in the use count of the consumable part 12. If the sensor 11 is a vibration sensor, the sensor 11 detects, for example, an increase in vibration amplitude caused by an increase in the use count of the consumable part 12. If the sensor 11 is a temperature sensor, the sensor 11 detects, for example, a rise in temperature caused by an increase in the use count of the consumable part 12.

Furthermore, the sensor 11 is capable of detecting a physical quantity that indicates abnormalities in the other part 13. In other words, the other part 13 is a component other than the consumable part 12, of which abnormalities can be detected by the sensor 11. For example, if there is a failure in the holder shown in the illustration, the consumable part 12 cannot be kept securely in place; therefore, the failure in the holder will be reflected in the physical quantity detected by the sensor 11.

The system 1 includes a control device 30. The control device 30 includes at least one processor and is configured to provide specific functions described below. The control device 30 is provided by a control unit that includes an electronic processing circuit, such as a computer. The control device 30 includes a CPU 31 that includes a processor core. The control device 30 includes a memory 32 (MMR) that stores a program containing multiple instruction codes executed by the CPU 31. The control device 30 includes a hardware circuit 33 (HDW) that performs a predetermined process. The hardware circuit 33 may be provided by an accelerator circuit or by the FPGA described below. The hardware circuit 33 enables real-time processing of at least a portion of the operations performed by the control device 30. The hardware circuit 33 may provide a diagnostic processing unit 42 described below.

The control device in this specification may be referred to as an electronic control unit (ECU: Electronic Control Unit). The control device or a control system is provided by (a) an algorithm as a plurality of logic called an if-then-else form, or (b) a learned model tuned by machine learning, e.g., an algorithm as a neural network.

The control device is provided by a control system including at least one computer. The control system may include a plurality of computers linked by data communication devices. The computer includes at least one processor (hardware processor) that is hardware. The hardware processor may be provided by the following (i), (ii), or (iii).

(i) The hardware processor may be at least one processor core that executes a program stored in at least one memory. In this case, the computer is provided by at least one memory and at least one processor core. The processor core is called a CPU: Central Processing Unit, a GPU: Graphics Processing Unit, a RISC-CPU, or the like. The memory may be also referred to as a storage medium. The memory is a non-transitory and tangible storage medium, which non-temporarily stores a program and/or data readable by the processor. The storage medium may be a semiconductor memory, a magnetic disk, an optical disk, or the like. The program may be distributed as a single unit or as a storage medium in which the program is stored.

(ii) The hardware processor may be a hardware logic circuit. In this case, the computer is provided by a digital circuit including a number of programmed logic units (gate circuits). The digital circuit is also called a logic circuit array, for example, ASIC: Application-Specific Integrated Circuit, FPGA: Field Programmable Gate Array, SoC: System on a Chip, PGA: Programmable Gate Array, or CPLD: Complex Programmable Logic Device. The digital circuit may include a memory storing programs and/or data. The computer may be provided by an analog circuit. The computer may be provided by a combination of a digital circuit and an analog circuit.

(iii) The hardware processor may be a combination of (i) and (ii). (i) and (ii) may be disposed on different chips or a common chip. In these cases, the portion (ii) may be also called an accelerator.

The control device, the signal source, and the control object provide various elements. At least some of these elements may be referred to as blocks, modules, or sections. Furthermore, elements included in the control system may be referred to as functional means only when intentional.

The control device 30 includes a plurality of processing units. Note that the order of the plurality of processing units is merely illustrative, and the order of the plurality of processing units may be rearranged as necessary to achieve the desired result. The order of the plurality of processing units is merely illustrative should be understood in the same way with respect to subsequent embodiments.

The control device 30 includes a signal processing unit 41. The signal processing unit 41 receives sensor signals from the sensor 11. As a result, the control device 30 acquires physical quantities that change in relation to wear from the consumable part 12.

The control device 30 includes a diagnostic processing unit 42. The diagnostic processing unit 42 diagnoses a degree of wear of the consumable part 12 based on the sensor signal. The diagnostic processing unit 42 outputs information indicating the service life of the consumable part 12 by diagnosing the consumable part 12 wear condition. The diagnostic processing unit 42 is configured to output information, including the remaining quantity of the consumable part 12, from the sensor signal by implementing a pre-trained model constructed using machine learning. The remaining quantity decreases as the consumable part 12 is used. The remaining quantity indicates a remaining quantity for which the consumable part 12 is usable. The remaining quantity includes the number of remaining processing cycles using the consumable part 12, the remaining processing distance using the consumable part 12, the remaining processing time using the consumable part 12, and the number of remaining items that can be processed using the consumable part 12. Thus, the remaining quantity serves as an appropriate indicator for expressing the service life of the consumable part 12 for each type of the consumable part 12, machining application, and workpiece.

The diagnostic processing unit 42 outputs condition of the consumable part 12 in order to calculate the remaining count of uses, as described below. The diagnostic processing unit 42 outputs the condition of the consumable part 12 in order to detect a failure of the consumable part 12. For example, if the sensor signal indicates abnormal behavior of the consumable part 12, this may indicate a failure of the consumable part 12. Furthermore, the diagnostic processing unit 42 outputs condition of the consumable part 12 in order to detect symptoms of a failure in the consumable part 12. For example, if a sensor signal intermittently indicates abnormal behavior in the consumable part 12, this may be a symptom of a failure of the consumable part 12.

The diagnostic processing unit 42 also diagnoses a condition of the other part 13 other than the consumable part 12. The condition of the other part 13 is diagnosed as a secondary check when fluctuations in the sensor signal do not indicate the behavior of the consumable part 12. If a fluctuation in the sensor signal do not indicate a behavior of the consumable part 12, the diagnostic processing unit 42 diagnoses a failure or a symptom of a failure in the other part 13.

The diagnostic processing unit 42 uses machine learning to diagnose wear condition of the consumable part 12. The results of this diagnosis include (i) a normal wear of the consumable part 12, (ii) a failure or a symptom of a failure of the consumable part 12, and (iii) a failure or a symptom of a failure of the other part 13 other than the consumable part 12. In subsequent processing, the remaining count is calculated for normal wear. In this embodiment, by comparing the remaining count with a production plan quantity, the replacement plan is planned to efficiently replace the consumable part 12 while satisfying the production plan quantity. Efficient replacement of the consumable part 12 is achieved by minimizing the number of replacements.

The control device 30 includes a remaining count calculation unit 43. The remaining count is one of the replace support information 60a. The replace support information 60a is information intended to assist in the replacement of the consumable part 12. The remaining count also represents the number of times the consumable part 12 can be used while maintaining normal functionality. As the consumption amount on the consumable part 12 increases, the remaining count decreases. If the consumable part 12 is new, the remaining count is a standard count set based on a standard quality of the consumable part 12. Note that “unused items” include both brand-new items being used for the first time and refurbished items that have undergone processing for reuse. If a consumable part 12 is used only once per workpiece, the remaining count may be interpreted as the number of workpieces for which the consumable part 12 can be used normally. The remaining count provides a key indicator for workers replacing the consumable part 12 to help them plan their work. Based on the remaining count and the usage frequency of the consumable part 12, it is possible to estimate an optimal replacement time down to the second.

The control device 30 includes a replacement time calculation unit 44. The replacement time is one of the replace support information 60a. The replacement time calculation unit 44 calculates the time at which the remaining count of the consumable part 12 reaches zero (0) based on, for example, the remaining count of the consumable part 12 and its frequency of use. Alternatively, the replacement time calculation unit 44 calculates the time at which the remaining count of uses for the consumable part 12 reaches or falls below the allowable count of uses, based on the remaining count of uses and the frequency of use of the consumable part 12. The allowable count is one example of the allowable quantity. The allowable count of cycles is the number of cycles at which the remaining life of the consumable part 12 can be considered to be zero (0). The replacement time is calculated in the seconds.

As a result, the control device 30 generates the replace support information including the remaining count and the replacement time based on acquired physical quantities. The remaining count indicates a remaining count for which the consumable part 12 is usable. The replacement time is the time at which the consumable part 12 is required to be replaced. The replacement time may be estimated based on the remaining count.

The control device 30 includes a replace information adjust unit 45. The replace information adjust unit 45 adjusts the information to provide the replace support information 60a for a efficient replacement of the consumable part 12. The replace information adjust unit 45 adjusts the replacement time so that, for example, when a plurality of the consumable parts 12 need to be replaced, multiple replacement operations can be performed consecutively to enable efficient replacement. Adjustments to the replacement time can be made by moving the replacement time forward or backward. The replace information adjust unit 45 may, for example, generate a replace sequence based on the remaining count and adjust the replace information to include this sequence. Furthermore, the replace information adjust unit 45 may adjust the replace information, for example, based on the production plan described below, to enable efficient replacement while ensuring that the production plan is met. The replace information adjust unit 45 may, for example, adjust the replacement time so that a downtime required to stop the facility 10 for the replacement of the consumable parts 12 is minimized.

The control device 30 includes a display processing unit 46. The display processing unit 46 performs processing to display the replace information on a display device 61, which will be described later. The display processing unit 46 displays character information, including the remaining count and the replacement time, on the display device 61. The display processing unit 46 can set or change a color of the characters and/or patterns to be displayed, as well as a font size. In addition, the display processing unit 46 may output sound in addition to performing display functions. Furthermore, the display processing unit 46 may change the color or size of the characters depending on a urgency of the replacement, as indicated by the replacement time. As a result, the control device 30 displays the replace support information on the display unit 61.

The control device 30 includes a report processing unit 47. The report processing unit 47 generates shared information related to a replace of the consumable part 12. The shared information is information that should be provided to the entities that make up the supply chain involving the consumable part 12. In addition, the report processing unit 47 transmits the shared information to the entities that make up the supply chain.

This allows the various entities within the supply chain to participate in improvement activities related to the consumable part 12 and the replacement of the consumable part 12. These improvement efforts include a variety of measures, such as improving the consumable part 12 itself, modifying the facility 10 to improve the replace process, and simplifying procedures for ordering and receiving the consumable part 12. Thus, the control unit 30 is configured to share information related to the replacement of the consumable part 12 among a plurality of entities.

The system 1 includes a server 50. The server 50 provides a storage device that stores predetermined information and provides requested information in response to requests from the control device 30.

The server 50 includes a production information storage unit 51. The production information storage unit 51 may, for example, store the number of processing works planned for a given day using the consumable part 12. The production plans may be set based on any time period, such as daily, weekly, or monthly. A processing number in a plan may be set as a number of processing in a plan for workpiece. The production information storage unit 51 may, for example, store frequency information of processing performed by the consumable part 12. The frequency information may be set as a cycle time associated with the consumable part 12. The production information storage unit 51 may contain process information indicating a order in which a plurality of the consumable parts 12 are used on the workpiece. The production information storage unit 51 may store information that includes a production plan indicating a number of processing of workpieces. If processing a plurality of types of workpieces, the production information storage unit 51 may store information that includes a production plan indicating a number of processing for each types of workpieces.

The server 50 includes a parts information storage unit 52. The parts information storage unit 52 stores parts information regarding the consumable part 12. The parts information may include, for example, details about a supplier of the consumable part 12. The parts information may include, for example, quality information indicating a quality of the consumable part 12. The quality information may include one or more items related to the quality of the consumable part 12. The quality information may include, for example, dimensional variations, shape variations, flatness variations, and a presence or absence of chipped edges. In addition, the quality information may include variations in material properties and/or variations in hardness. The parts information may include lot information for the consumable part 12. The lot information indicates a manufacturing unit for the consumable part 12. The lot information may, for example, indicate slight variations in material quality resulting from differences in production dates. The part information storage unit 52 may store part information that includes classification information indicating whether the consumable component 12 is a reusable type or a one-time type.

The server 50 includes a facility information storage unit 53. The facility information storage unit 53 stores information related to the facility 10. The facility information storage unit 53 may, for example, contain information about the supplier of the facility 10.

The system 1 includes an output device 60. The output device 60 outputs information related to the replacement of the consumable part 12. The output device 60 facilitates sharing of information among the plurality of entities that make up the supply chain.

The output device 60 includes a display device 61 for displaying replace support information. The display device 61 displays information to the worker. The worker is a person responsible for replacing the consumable part 12. The display device 61 may be provided by an LCD monitor installed together with the control device 30. Alternatively, or in addition, the display device 61 may be provided by a tablet monitor that the worker can carry.

The worker is provided with the replace support information 60a from the display device 61. The worker can formulate and implement a work plan designed to reduce the workload based on the replace support information 60a. For example, the worker can replace the consumable part 12 under the control of the system 1 based on the replace support information 60a. For example, the worker can determine an extent to which the replacement of the consumable part 12 reduces the workload based on the replace support information 60a. For example, the worker can plan and execute orders for replacement part for the consumable part 12 based on the replace support information 60a.

The output device 60 includes a communication device 62. The communication device 62 sends a report generated by the report processing unit 47 to the suppliers that make up the supply chain. The suppliers that receive the reports include, for example, a facility supply entity 63 and a parts supply entity 64.

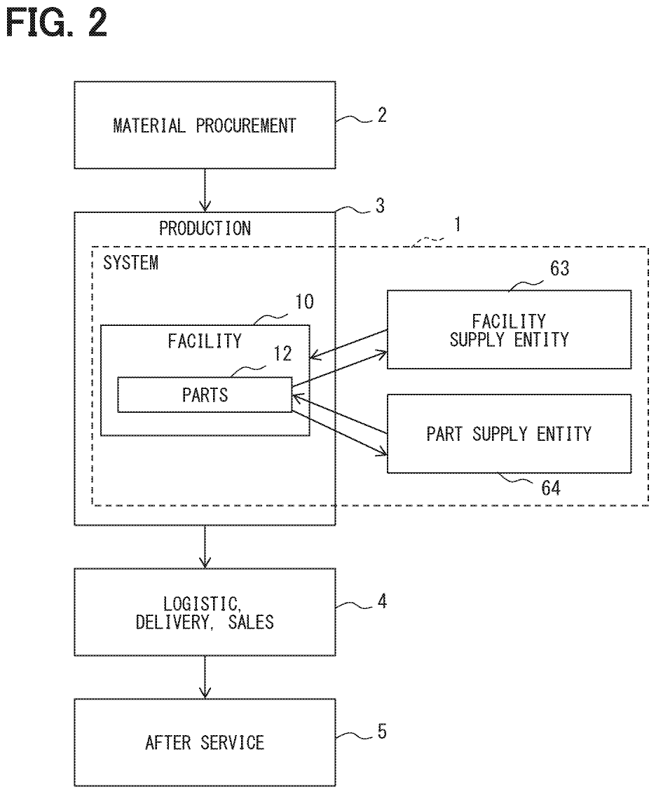

FIG. 2 shows a supply chain associated with the system 1. The drawing illustrates a series of the supply chain comprising: a material procurement stage 2; a manufacturing stage 3; a logistics, delivery, and sales stage 4; and an after-sales service stage 5. The facility supply entity 63 is a supplier of the facility 10. The parts supply entity 64 is a supplier of the consumable part 12. In addition, the drawing shows arrows pointing from the consumable part 12 to the facility supply entity 63 and the parts supply entity 64. These arrows illustrate flows of reports provided to the facility supply entity 63 and the parts supply entity 64 in the system 1 in connection with the replacement of the consumable part 12.

The report provided to the facility supply entity 63 contains information that contributes to improve the facility 10. The report may contain one or more of the items listed below. The report may, for example, include (i) an operating environment of the consumable part 12. The operating environment may include, for example, if the consumable part 12 is a cutting tool, a temperature at a cutting portion, a relative speed between the workpiece and the cutting tool, a feed rate of the cutting tool, and a supply rate of cutting fluid. The report may, for example, include (ii) sensor signals in a predetermined period of time or a predetermined duration prior to the replacement of the consumable part 12. The sensor signals may provide important information regarding the replacement of the consumable part 12. The report may include, for example, (iii) a utilization rate of the facility 10. The report may include, for example, (iv) a stoppage history of the facility 10 caused by a failure and a failure symptom. The facility supply entity 63 can consider and implement improvements to the facility 10 aimed at increasing the facility 10 utilization rate based on the report. Based on the report, the facility supply entity 63 can consider and implement improvements to the facility 10 to facilitate the resumption of operations following a shutdown.

The reports provided to the parts supply entity 64 contain information that contributes to the improvement of the consumable part 12. The report may contain one or more of the items listed below. The report may, for example, include (i) an operating environment of the consumable part 12. The operating environment may include, for example, if the consumable part 12 is a cutting tool, a temperature at a cutting portion, a relative speed between the workpiece and the cutting tool, a feed rate of the cutting tool, and a supply rate of cutting fluid. The report may, for example, include (ii) sensor signals in a predetermined period of time or a predetermined duration prior to the replacement of the consumable part 12. The sensor signals may provide important information regarding the replacement of the consumable part 12. The report may, for example, include (ii) variations in the quality of the consumable part 12 that is delivered. For example, the report may include (iii) a forecast of an order quantity of the consumable part 12. The parts supply entity 64 may study operating conditions that depend on the quality of the consumable parts 12, and can consider and implement improvements to the quality of the consumable parts 12 based on the report. The parts supply entity 64 can plan and execute production plans for consumable parts 12 based on the report.

As a result, the system 1 can provide useful information to suppliers involved in the replacement of the consumable part 12 within the supply chain centered on the manufacturing entities.

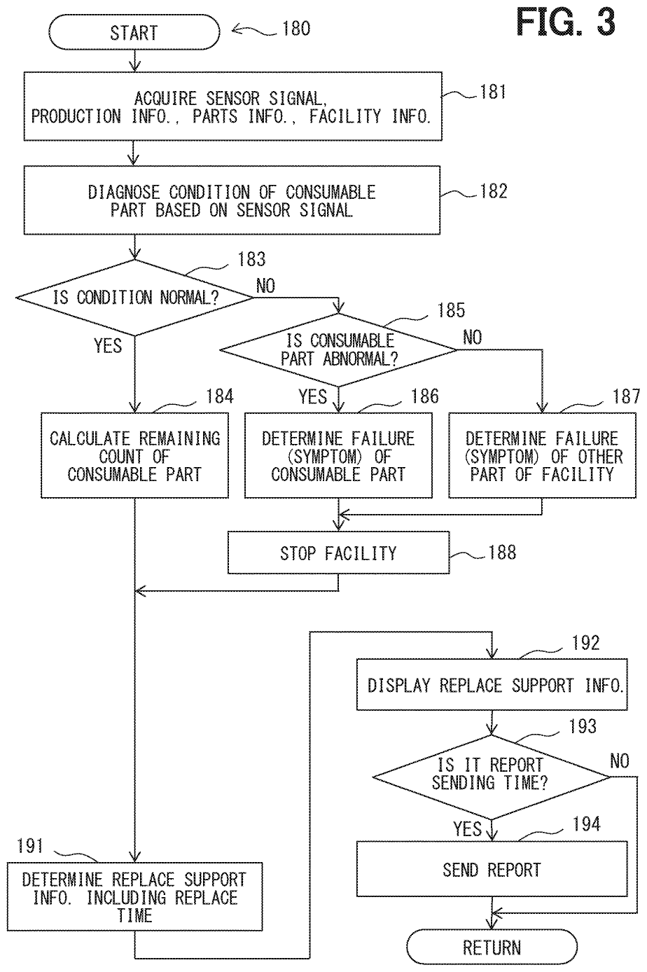

FIG. 3 is a flowchart illustrating the program executed by the control unit 30. Note that the order of the steps shown in the flowchart is merely illustrative, and the order of the steps may be rearranged as long as the objective is achieved. The order of the plurality of steps is merely illustrative should be understood in the same way with respect to subsequent embodiments. This flowchart illustrates a sequence of steps performed by the control device 30. The process 180 is executed continuously over a long period during which the facility 10 is in operation. As a result, the process 180 can accurately determine the service life of the consumable part 12.

In step 181, the control device 30 acquires the information necessary for series of processes. The required information includes sensor signals. The sensor signals are obtained from the sensor 11. In addition, the required information includes production data, parts information, and facility information. The production information, the parts information, and the facility information are retrieved from the server 50. The step 181 provides a signal processing unit 41.

In step 182, the control unit 30 diagnoses the condition of the consumable part 12 based on the sensor signal. The condition of the consumable part 12 is diagnosed based on the sensor signals. The processing in the step 182 is performed by a pre-trained model trained using machine learning. The step 182 provides a diagnostic processing unit 42.

In step 183, the control device 30 determines whether a diagnostic result from the step 182 is normal. The diagnosis in the step 182 determines whether the sensor signal is normal or abnormal. In step 183, if the sensor signal is normal, the process branches to YES and proceeds to step 184. In the step 183, if the sensor signal is abnormal, the process branches to NO and proceeds to step 185.

In the step 184, the control device 30 determines that the facility 10 is functioning normally and calculates the remaining count of the consumable part 12. The step 184 provides a remaining count calculation unit 43.

In the step 185, the control device 30 determines whether the sensor signal anomality is caused by the consumable part 12. In the step 185, if the sensor signal abnormality is caused by the consumable part 12, the process branches to YES and proceeds to step 186. In the step 185, if the sensor signal abnormality is not caused by the consumable part 12, the process branches to NO and proceeds to step 187.

In the step 186, the control device 30 determines that a failure of the consumable part 12 or a failure symptom of the consumable part 12 have appeared.

In the step 187, the control device 30 determines that a failure has occurred in the other part 13 other than the consumable part 12, or that a failure symptom have appeared in the other part 13 other than the consumable part 12.

If the process proceeds via the step 186 or the step 187, the control device 30 stops the facility 10 in the step 188. Note that in the step 188, the operation of the facility 10 may be continued without stopping the facility 10.

In step 191, the control device 30 determines the replace support information 60a, which includes the replacement time. If the system proceeds through the step 184, the time at which the remaining count of the consumable part 12 reaches zero (0) is predicted based on the cycle time, and the replacement time is determined. If the process proceeds via the step 186 or the step 187, the current time is determined as the replacement time for replacing the part that causes the sensor signal abnormality.

In step 192, the control device 30 displays the replace support information 60a on the display device 61.

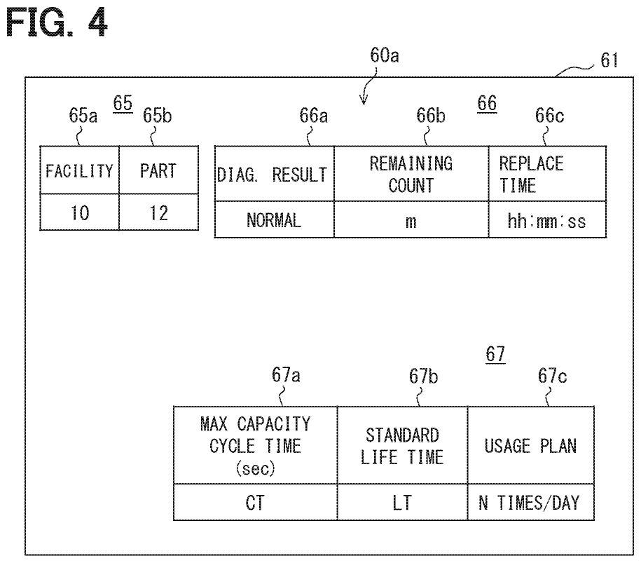

FIG. 4 shows an example of the replace support information 60a. The specific figures provided are merely examples intended to aid understanding and do not serve as a basis for interpreting the disclosure of this specification in a restrictive manner. It should be understood that the numerical values provided are merely illustrative and apply equally to the preceding and subsequent embodiments.

The display device 61 is displaying the replace support information 60a. The replace support information 60a includes a facility ID 65a that identifies the facility 10 and a part ID 65b that identifies the consumable part 12. The facility ID 65a and the part ID 65b are also referred to as fixed static information 65. The replace support information 60a includes the diagnostic result 66a, the remaining count 66b, and the replacement time 66c. The diagnostic result 66a is the diagnostic result for the component that was diagnosed as abnormal. The diagnostic result 66a, the remaining count 66b, and the replacement time 66c are collectively referred to as dynamic information 66, which may change dynamically.

The replace support information 60a includes reference information 67 for calculating the dynamic information 66. The reference information 67 includes, for example, maximum capacity 67a, standard service life 67b, and usage plan 67c. The maximum capacity 67a may be also known as the cycle time.

Returning to FIG. 3, in step 193, the control device 30 determines whether a sending time for the report has arrived. The sending time is set, for example, at regular intervals.

In step 194, the control device 30 sends the report. The report is sent to the facility supply entity 63 and/or the parts supply entity 64.

According to this embodiment, a worker is not merely required to replace parts. Workers tasked with replacing parts are shown the remaining count for the consumable part 12. As a result, the workers may plan their replacement work, which reduces their workload. The manufacturing entity may reduce labor required to replace the consumable part 12 and accurately forecast the number of the consumable parts 12 to be ordered.

According to this embodiment, information regarding consumable parts and their replacement can be provided to suppliers within the supply chain via reports. For example, it can provide the facility supply entity with data indicating the utilization rate of the facility 10 and/or a downtime history of the facility 10 due to failures (including early warning symptoms of the failures). It is possible to notify the parts supply entity variations in the quality of the consumable parts 12 and a forecast of a order quantity for the consumable parts 12.

As a result, this can encourage suppliers to improve their parts and/or facility. For example, the facility supply entity can identify portion of the facility 10 that require improvement and develop and implement specific improvement measures. For example, a parts supply entity may provide advice to a manufacturing entity regarding a handling of the consumable part 12, and may plan and implement improvements to the consumable parts 12.

### Second Embodiment

This embodiment is a modified embodiment of the preceding embodiment which is provided as a basic embodiment. In the above embodiment, the consumable part 12 was a single component. Alternatively, in this embodiment, the facility 10 includes a plurality of consumable parts 212a, 212b, and 212n. Note that in the illustrated example, there are three consumable parts; however, this is merely an example, and the number may be two or four or more.

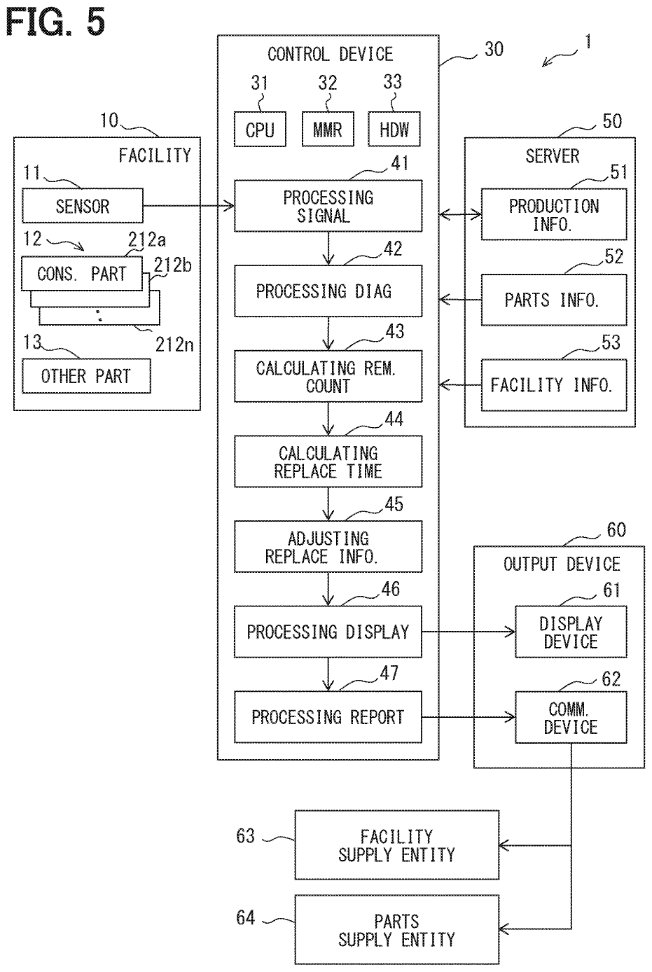

As shown in FIG. 5, the facility 10 includes a plurality of consumable parts 212a, 212b, and 212n. In this embodiment, replace support information 60a are generated and output for each of the pl;urality of consumable parts 212a, 212b, and 212n.

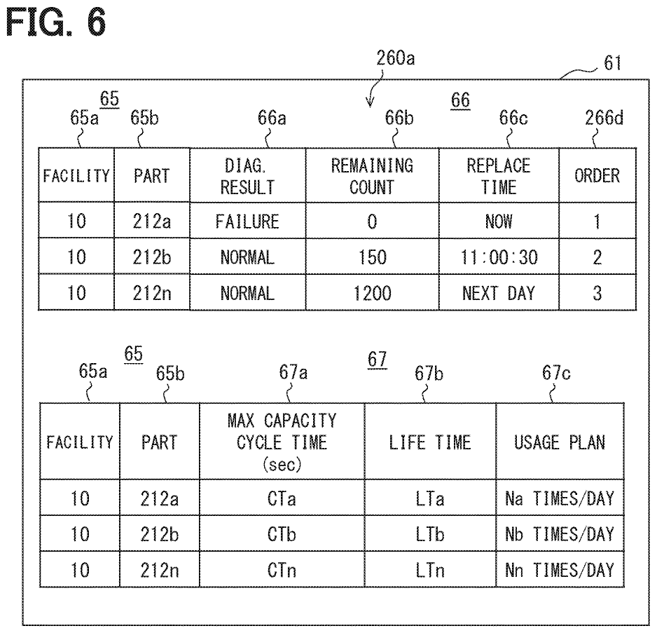

FIG. 6 shows the replace support information 260a displayed on the display device 61. In this embodiment as well, the replace support information 60a includes static information 65, dynamic information 66, and rationale information 67. In this embodiment, the replace support information 60a includes replace order information 266d regarding the order of replacement among the plurality of consumable parts 212a, 212b, and 212n.

In the illustration, a failure has occurred in the consumable part 212a. For this reason, the remaining count of the consumable part 212a is zero (0). Furthermore, the replacement time is now. In other words, the replacement time indicates an immediate replacement. The consumable part 212b is in good condition and has 150 of the remaining count. The replacement time for the consumable part 212b is specified in seconds. The consumable part 212n has 1200 of the remaining count that is sufficiently greater than the planned number of uses Nn. In the illustration, the replacement priority is set so that the consumable part 212a is the first, the consumable part 212b is the second, and the consumable part 212n is the third.

According to this embodiment, the worker is not merely required to replace parts. The workers may plan and coordinate the replacement of a plurality of the consumable parts 12, thereby reducing their workload.

### Third Embodiment

This embodiment is a modified embodiment of the preceding embodiment which is provided as a basic embodiment. In the above embodiment, the facility 10 subject to management was a single piece of facility. Alternatively, in this embodiment, the system 10 comprises a plurality of facilities 310a, 310b, and 310n. Note that in the illustrated example, there are three of the facility 10; however, this is merely an example, and the number may be two or four or more.

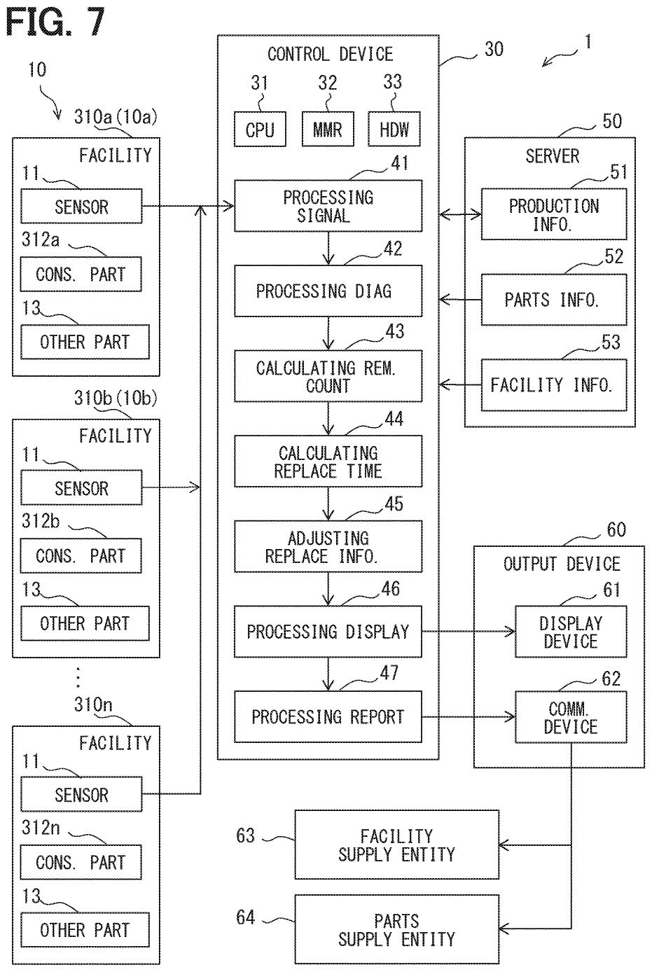

As shown in FIG. 7, the facility 10 comprises a plurality of facilities 310a, 310b, and 310n. In this embodiment, replace support information 60a are generated and output for each of the consumable parts 312a, 312b, and 312n of the plurality of facilities 310a, 310b, and 310n.

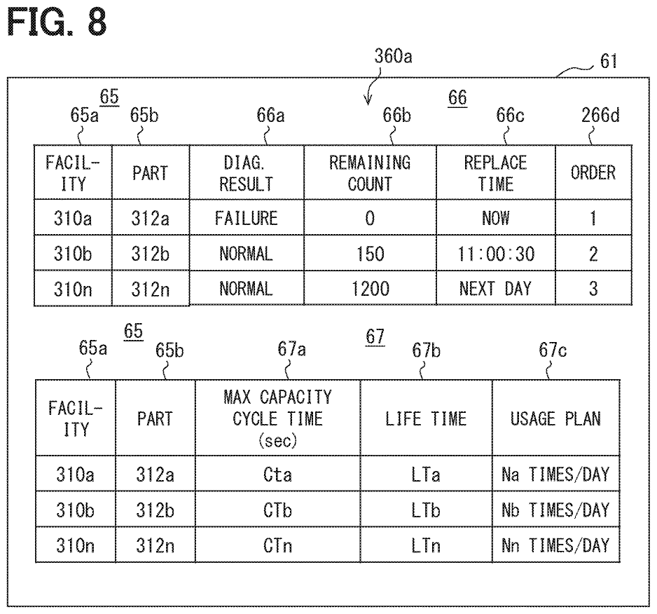

FIG. 8 shows the replace support information 360a displayed on the display device 61. In this embodiment as well, the replace support information 60a includes static information 65, dynamic information 66, and rationale information 67. In this embodiment, the replace support information 60a includes replace order information 266d regarding the order of replacement among the plurality of consumable parts 312a, 312b, and 312n.

In this embodiment as well, the worker is not merely required to replace parts. The workers may plan and coordinate the replacement of a plurality of the consumable parts 12, thereby reducing their workload.

### Fourth Embodiment

This embodiment is a modified embodiment of the preceding embodiment which is provided as a basic embodiment. In the above embodiment, the system 1 is implemented within a geographically limited area. The system 1 is implemented, for example, within a single factory. Alternatively, in this embodiment, the system 1 comprises a plurality of systems 401a, 401b, and 401n that are geographically separated from one another. The plurality of systems 401a, 401b, and 401n may be deployed at a plurality of geographically dispersed factories. Here, the phrase “geographically dispersed from one another” refers to situations where a plurality of systems are located in different factories, in different administrative districts, and/or in different countries. Note that in the illustrated example, the number of the systems 1 is three; however, this is merely an example, and the number may be two or four or more.

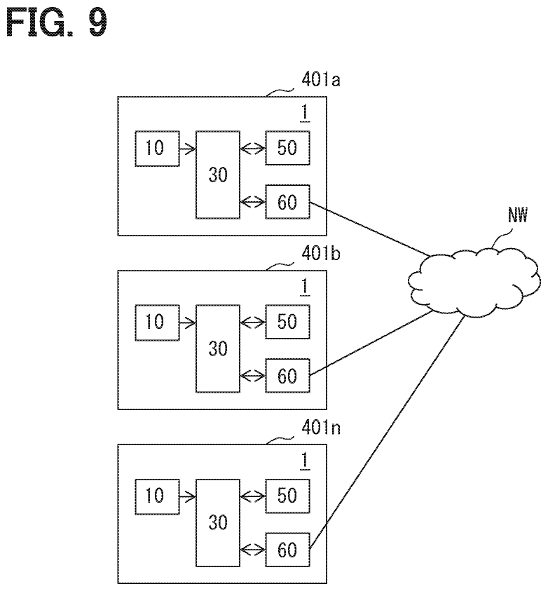

As shown in FIG. 9, a plurality of systems 401a, 401b, and 401n are interconnected via a network NW for telecommunications. The plurality of systems 401a, 401b, and 401n constitute a single integrated system. The system 401a may display and send the replace support information 60a for the consumable parts not only for the facility 10 belonging to itself but also for the facility 10 belonging to other systems 401b and 401n. In this embodiment, a plurality of production sites, both domestic and international, are connected via a network. In addition, information regarding the replacement of the consumable part (60a) is shared so that they can all access it.

This embodiment highlights differences in equipment and/or components among the plurality of systems 401a, 401b, and 401n. In other words, it visualizes differences in the facility and/or parts across a plurality of systems 401a, 401b, and 401n. Even for the same facility or the same consumable parts, differences such as those listed below are expected to result in variations in the replacement time of the consumable parts. For example: (i) The parts supply entity of the consumable parts are different; (ii) there are differences in facility maintenance intervals; (iii) there are geographical and climatic differences, resulting in different environmental conditions where the facility is installed; (iv) there are differences in worker skill levels.

According to this embodiment, it is possible to manage consumable parts across the plurality of systems. More specifically, it allows for the centralized management of parts across a plurality of locations. From another perspective, it allows for the management of total production across a plurality of locations. From another perspective, issues specific to a particular location among a plurality of sites come to light.

### Fifth Embodiment

This embodiment is a modified embodiment of the preceding embodiment which is provided as a basic embodiment. In the above embodiment, the quality of the consumable parts 12 is not included in the scope of management. Alternatively, in this embodiment, the condition of the consumable part 12 is reflected in the replace support information 60a.

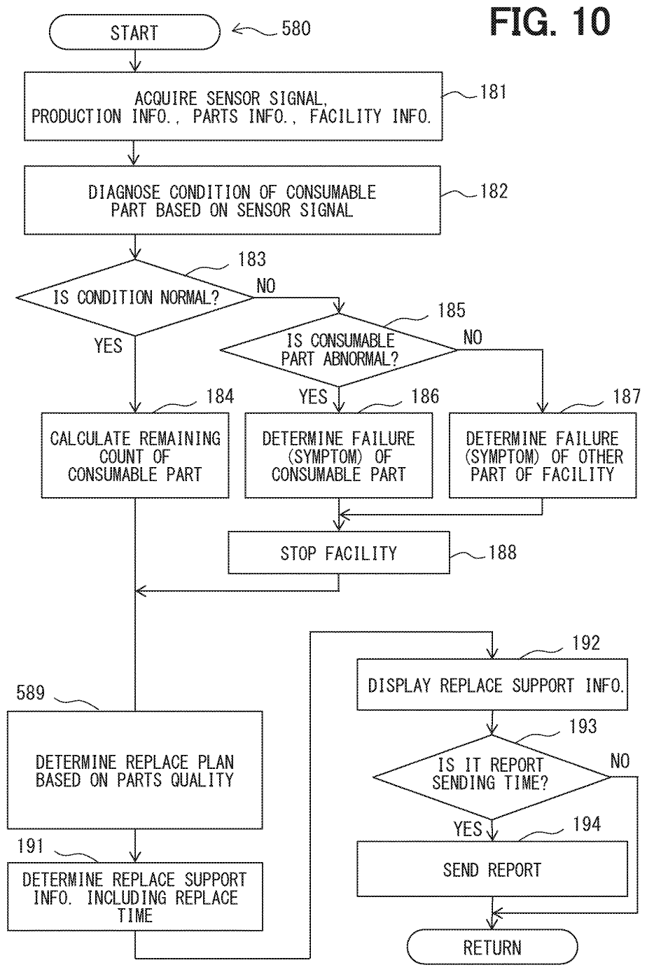

As shown in FIG. 10, process 580 includes step 589 following the steps 184 and 188. The step 589 is located before the step 191. In the step 589, the control device 30 determines the replacement plan based on the quality of the consumable part 12. The replacement plan is adjusted to optimize replacement process based on the quality of the consumable part 12. The replacement plan determined in the step 589 is reflected in the replace support information 60a in the step 191 subsequently. Furthermore, the replacement plan determined in the step 589 is reflected in the display on the display device 61 in the step 192 subsequently. As a result, the workers may perform efficient replacement operations based on the quality of the consumable part 12.

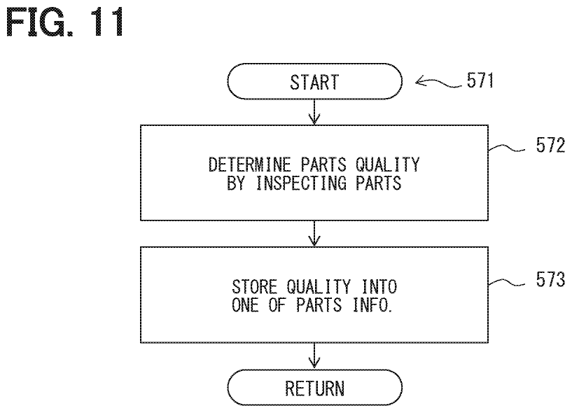

FIG. 11 shows a flowchart for acquiring and registering the quality of consumable part 12. Process 571 identifies the quality of the consumable part 12 and registers the quality information as a part of the part information. In this embodiment, the quality of the consumable part 12 is registered in advance before the consumable part 12 is put into use. The quality of the consumable part 12 may be determined by conducting an acceptance inspection at the stage when the part is received at the factory where System 1 is in operation. Alternatively, or in addition, the quality of the consumable part 12 may be specified based on a request from the parts supply entity.

In step 572, the control device 30 determines the quality of the consumable part 12. Quality can be acquired by inspecting parts. Quality can be identified, for example, for each production lot of delivered parts. Quality may be specified by various quality factors, such as material and sharpness.

In step 573, the control device 30 adds the quality of the consumable part 12 to the part information stored in the part information storage unit 52. As a result, the control device 30 may retrieve quality information for the consumable part 12 from the part information storage unit 52.

In this embodiment, the following processes, for example, are implemented. Here, it is assumed that a product Pa is processed in parallel by a plurality of facilities 10a and 10b. It is assumed that there are differences in production capacity among the various facilities. The production capacity of the facility 10a is higher than that of the facility 10b. Furthermore, it is assumed that wear of the consumable part 12 in the facility 10a occurs at a faster rate than that of the consumable part 12 in the facility 10b. It is assumed that the quality of the consumable parts 12 is managed on a per-lot basis and stored in the part information storage unit 52.

In one example, the control device 30 determines the replacement plan in the step 589 as described in (i) and (ii) below: (i) Use replacement part from the relatively high-quality lot to replace the consumable part 12 of the facility 10a; (ii) Use replacement part from the relatively low-quality lot to replace the consumable part 12 of the facility 10b. Determination of such the replacement plan is effective in reducing time difference between replacement times.

In other one example, the control device 30 determines a replace plan in the step 589 as described in (i) and (ii) below: (i) Use replacement part from the relatively high-quality lot to replace the consumable part 12 of the facility 10a; (ii) Use replacement part from the relatively low-quality lot to replace the consumable part 12 of the facility 10b. Deciding on such a replace plan is effective in reducing the number of replacements required for the facility 10b.

In this embodiment, the following processes, for example, are implemented. Here, it is assumed that a product Pa is processed in parallel by a plurality of facilities 10a and 10b. Assume that a deterioration of the facility 10b is more advanced than that of the facility 10a. Assume that a processing yield of the product on the facility 10b is lower than that on the facility 10a.

In one example, the control device 30 determines a replace plan in the step 589 as described in (i) and (ii) below: (i) Use replacement part from the relatively high-quality lot to replace the consumable part 12 of the facility 10a; (ii) Use replacement part from the relatively low-quality lot to replace the consumable part 12 of the facility 10b. This replacement plan is effective in mitigating a decline in the processing yield of the facility 10a.

In one example, the control device 30 determines a replace plan in the step 589 as described in (i) and (ii) below: (i) Use the consumable part 12 having a relatively low quality to replace the consumable part 12 of the facility 10a; (ii) Use the consumable part 12 having a relatively high-quality to replace the consumable part 12 of the facility 10b. This replace plan is effective in improving the processing yield of the facility 10b.

In this embodiment, the control device 30 is configured to determine a replacement plan based on the quality information stored in the component information storage unit 52. The control device 30 is configured to generate and output the replace support information, including the replacement plan. The replacement plan is designed to replace a single consumable part 12 with a consumable part 12 of relatively higher quality. The replacement plan is designed to replace the other consumable part 12 with the consumable part 12 of relatively lower quality. The replace support information specifies, for each replacement time, an old one of the consumable part 12 that has reached its maximum number of the use count and a new one of the consumable part 12 with the selected quality.

According to this embodiment, the facility 10 is capable of achieving performance commensurate with the quality of the new consumable parts 12. If a replacement is performed on a single piece of the facility 10, the intended performance can be achieved by using the consumable part 12 of the intended quality. If the replacement is performed across a plurality of facilities 10, it is possible to achieve superior overall performance by leveraging differences in performance between the plurality of facilities.

### Sixth Embodiment

This embodiment is a modified embodiment of the preceding embodiment which is provided as a basic embodiment. In the above embodiment, production process is not included in the scope of management. Alternatively, in this embodiment, a positioning of consumable parts 12 in the production process is reflected in the replace support information 60a.

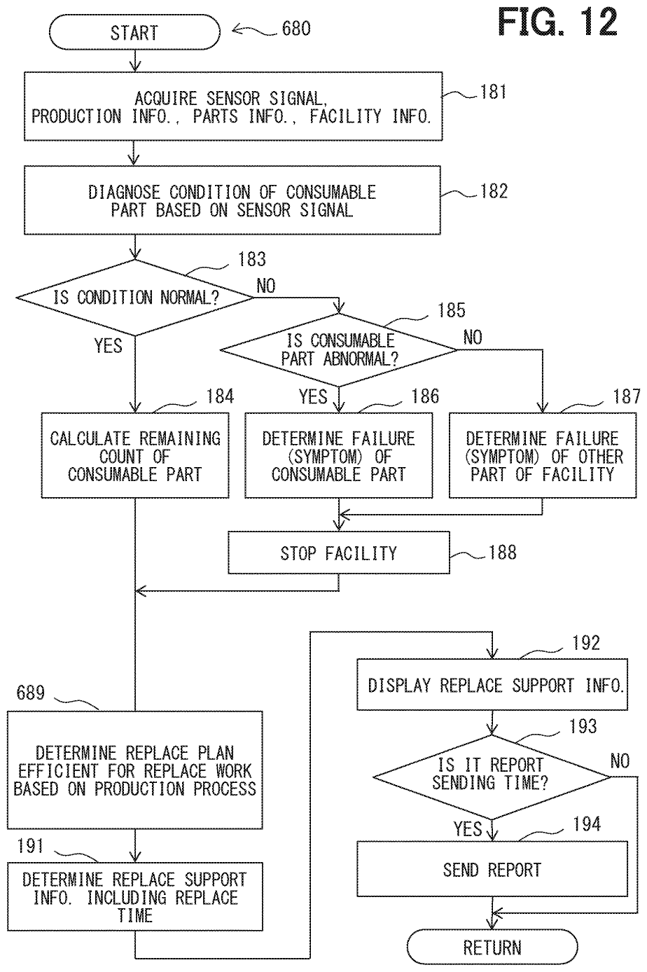

As shown in FIG. 12, process 680 includes step 689 instead of the step 589. In the step 689, the control device 30 determines an efficient replacement plan for the consumable part 12 based on the process information from the facility 10. The control device 30 retrieves process information from the production information storage unit 51. The control device 30 is configured to adjust the remaining count and the replacement time based on process information. Process information is indicated, for example, by an order in which the consumable parts 12 are used. The replacement plan is adjusted based on process information to optimize the replacement process for greater efficiency. If an abnormality is suspected in one or more of the consumable parts 12, the control device 30 adjusts the remaining count and the replacement time based on process information so that the consumable part 12 most likely to be abnormal is replaced first. The control device 30, for example, sets the remaining count of the consumable part 12 that is highly likely to be abnormal to zero (0) and sets the replacement time to the current time.

The replacement plan determined in the step 689 is reflected in the replace support information 60a in the step 191 subsequently. Furthermore, the replacement plan determined in the step 689 is reflected in the display on the display device 61 in the step 192 subsequently.

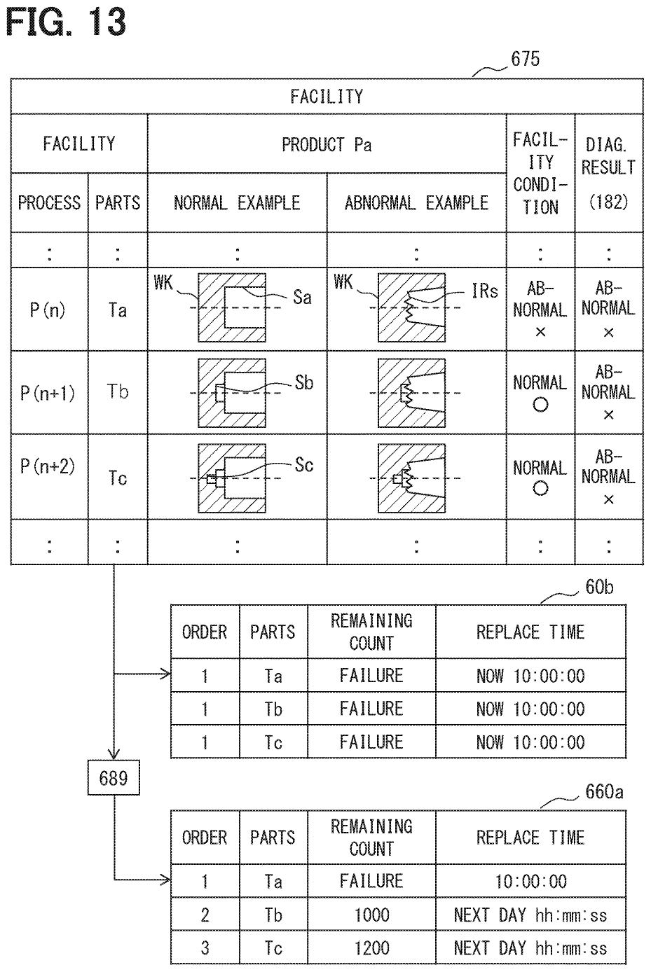

FIG. 13 shows the process chart 675, which illustrates the production process of the facility 10. Furthermore, the drawing shows a display example of the replace support information 60b in the comparative example and a display example of the replace support information 660a in this embodiment. Note that the replace support information 60b in the comparative example is similar to the replace support information 260a and 360a in the second and third embodiments, respectively.

It is assumed that the production process includes the steps described below. The product Pa includes a workpiece WK. In this embodiment, a plurality of the consumable parts Ta, Tb, and Tc are used. The plurality of the consumable parts are used sequentially for a single piece of the workpiece WK. The shape of the workpiece WK is assumed to be either a normal example and an abnormal example. In the normal example, the workpiece WK is machined in the order described below. The production process includes a process P(a), in which the workpiece WK is processed by the facility Fa. In the process P(a), a shape Sa is machined. The production process includes a process P(b), in which the workpiece WK is processed by the facility Fb following the process P(a). In the process P(b), a shape Sb is machined. The production process includes a process P(c), in which the workpiece WK is processed by the facility Fc following the process P(b). In the process P(c), a shape Sc is machined. It is assumed that a machining accuracy in the process P(a), the process P(b), and the process P(c) increases progressively.

In the abnormal example, the workpiece WK is machined in the order described below. If an abnormality occurs in the facility Fa, an abnormal shape IRs is machined into the part WK. Due to the abnormal shape IRs, abnormal shapes are also produced in the facility Fb. Due to the abnormal shape IRs, abnormal shapes are also produced in the facility Fc.

In this production process, it is assumed that only the facility Fa has an actual failure (marked with an “X”). Due to the abnormal shape IRs, a shape of the workpiece WK may be an abnormal shape. On the other hand, the facility Fb and Fc are actually functioning normally (marked with a circle). However, in every process step, the sensor 11 detects an abnormality caused by the abnormal shape IRs. For this reason, the result of the diagnostic process in the step 182 is that all processes are determined to be abnormal (marked with an “X”).

In this case, in the comparative example, failures are detected in all of the consumable parts Ta, Tb, and Tc. As a result, the replacement time is set to the current time and displayed. Workers who see this replace support information 60b is required to perform an immediate replacement at the current time.

In contrast, in this embodiment, the processing steps included in the production information are retrieved from the production information storage unit 51. Furthermore, in the step 689, the control device 30 determines that only the consumable part Ta of the facility Fa has failed, based on the processing sequence of the facility. Consequently, the consumable part Tb for the facility Fb and the consumable part Tc for the facility Fc are not classified as failures.

Thus, in this embodiment, since the replacement plan is determined based on the production process, the number of times the consumable part 12 needs to be replaced can be minimized. Note that while this embodiment describes an example in which three pieces of facilities perform processing in sequence, it is not limited to this example. The production process may be assumed that a plurality of the consumable parts 12 in a single one of the facility sequentially process a part.

### Seventh Embodiment

This embodiment is a modified embodiment of the preceding embodiment which is provided as a basic embodiment. In the above embodiment, production planning is not included in the scope of management. Alternatively, in this embodiment, the impact of replacing consumable parts 12 on the production plan is reflected in the replace support information 60a in order to mitigate that impact.

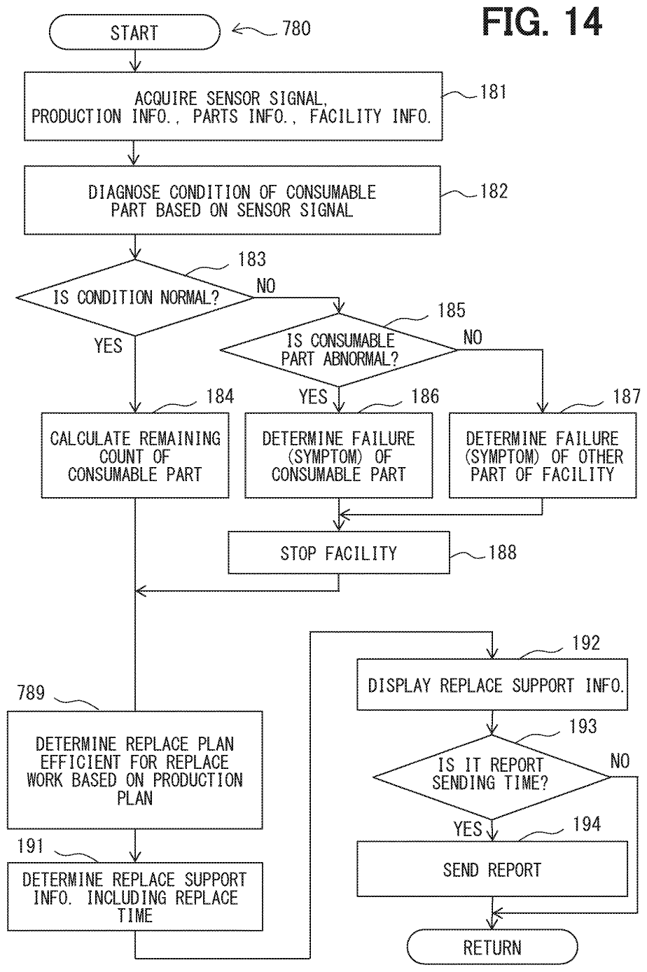

As shown in FIG. 14, process 780 includes step 789 instead of the step 689. In the step 789, the control device 30 determines a replacement plan which is efficient for replacing the consumable part 12 based on the production schedule for the facility 10. The production plan is indicated, for example, by the planned production volume of products manufactured by the facility 10. The replacement plan is determined, for example, to minimize the number of downtimes of the facility 10 while meeting the production plan quantity.

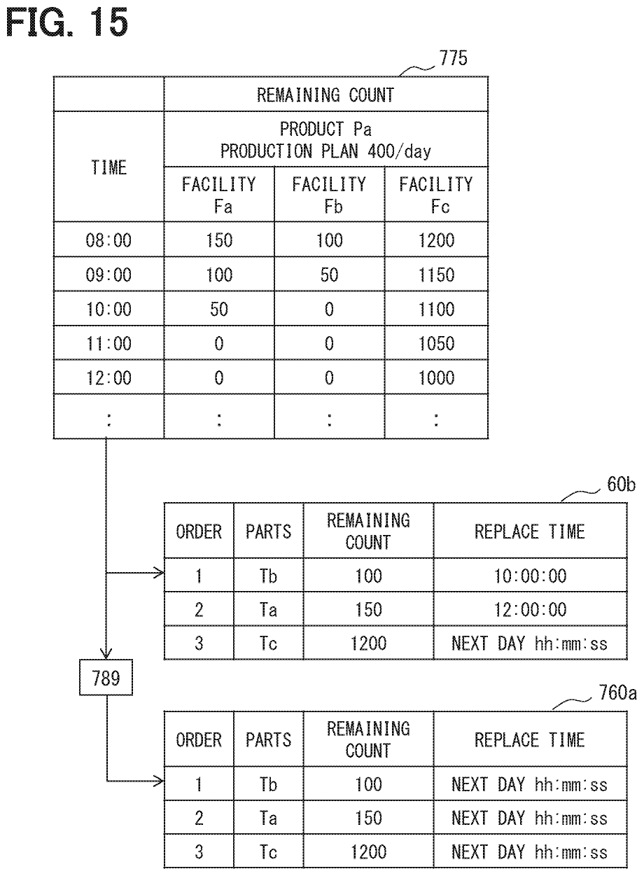

FIG. 15 shows a planing chart 775, which indicates the production plan for the product Pa (400 units per day) and the remaining count. Furthermore, the drawing shows a display example of the replace support information 60b in the comparative example and a display example of the replace support information 760a in this embodiment.

It is assumed that the production plan quantity per day for the product Pa is 400 units. It is assumed that the cycle time for the product Pa is 72 seconds. It is assumed that processing capacities of the facility Fa, Fb, and Fc are equal and the production quantity per hour is 50 units. Therefore, in this embodiment, the consumable part is one of a plurality of the consumable parts Ta, Tb, and Tc that can be selectively used for a single workpiece. The plurality of the consumable parts Ta, Tb, and Tc may be used interchangeably for a single workpiece. The plurality of the consumable parts Ta, Tb, and Tc may be used selectively for a single workpiece.

In the comparative example, all three facilities Fa, Fb, and Fc are in operation. In this case, at the time of 08:00, the replace support information 60 a displayed on the display device 61 includes the replacement time of 11:00:00 for the consumable part Ta of the facility Fa and the replacement time of 10:00:00 for the consumable part Tb of the facility Fb. In other words, in the comparative example, the worker is instructed to perform two replacements.

On the other hand, in this embodiment, which proceeds via the step 789, the production plan is adjusted to minimize the number of replacements while satisfying a production plan, and the replace support information 760a is determined. In the example shown, the replacement time for the consumable part Tb and the consumable part Ta have been adjusted. In the step 789, the control device 30 adjusts the production plan to extend the operating time of the facility Fc, which has a relatively high value of the remaining count, in order to avoid the replacement of the consumable part Tb and the consumable part Ta. In other words, the production plan is adjusted to postpone the replacement time. Specifically, the control unit 30 is configured to adjust a distribution of workpieces to a plurality of consumable parts. This distribution is adjusted to satisfy the production plan stored in the production information storage unit 51 and to ensure that the replacement times for a plurality of the consumable parts approach one another. It is desirable to adjust the replacement time for the plurality of the consumable parts into an equal time.

For example, if the facility Fc alone can satisfy the production plan of 400 units per day, the production plan will be adjusted so that only the facility Fc is operated. The production plan is adjusted to minimize the number of replacement. For example, the production plan may be adjusted so that the replacement times for at least two of the facilities approach one another. In this embodiment, it is possible to adjust the production plan so that the replacement times for at least two of the facilities occur simultaneously, thereby improving the efficiency of the replacement process.

In the example shown, after the production plan is adjusted, the remaining count for the facility Fb is kept at 100, the remaining count for the facility Fa is kept at 150, and only the remaining count for the facility Fc decreases from 1,200. In other words, a distribution of production number among the facilities is intentionally widened. In other words, by diagnosing the condition of the consumable part 12, it is possible to postpone the replacement time of the consumable part 12 which has the replacement time predicted relatively close to arrival. In other words, by diagnosing the condition of the consumable part 12, it is possible to bring advance the replacement time of the consumable part 12 which has the replacement time predicted relatively far to come.

According to this embodiment, it is possible to minimize the number of replacements for a plurality of the consumable parts 12 while satisfying production plans and performing replacement operations efficiently.

### Eighth Embodiment

This embodiment is a modified embodiment of the preceding embodiment which is provided as a basic embodiment. In the above embodiment, the production plan for a single product is adjusted. Alternatively, in this embodiment, the production plans for a plurality of products are coordinated.

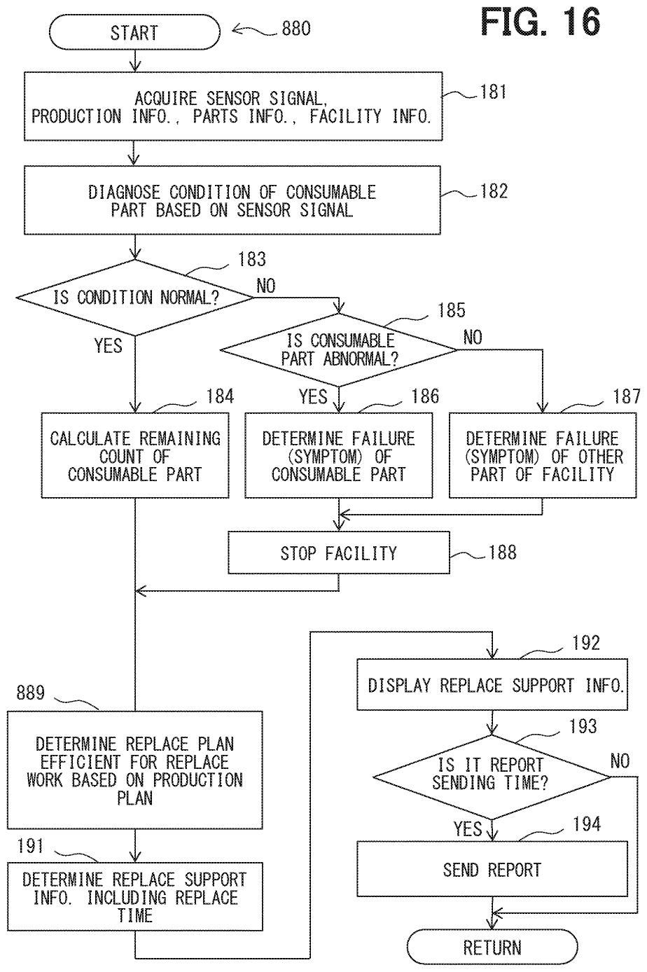

As shown in FIG. 16, process 880 includes step 889 instead of the step 789. In the step 889, the control device 30 determines a replacement plan which is efficient for replacing the consumable part 12 based on the production schedule for the facility 10. The production plan is indicated, for example, by the planned production quantity of products manufactured by the facility 10. The replacement plan is determined, for example, to minimize the number of downtimes of the facility 10 while meeting the production plan quantity.

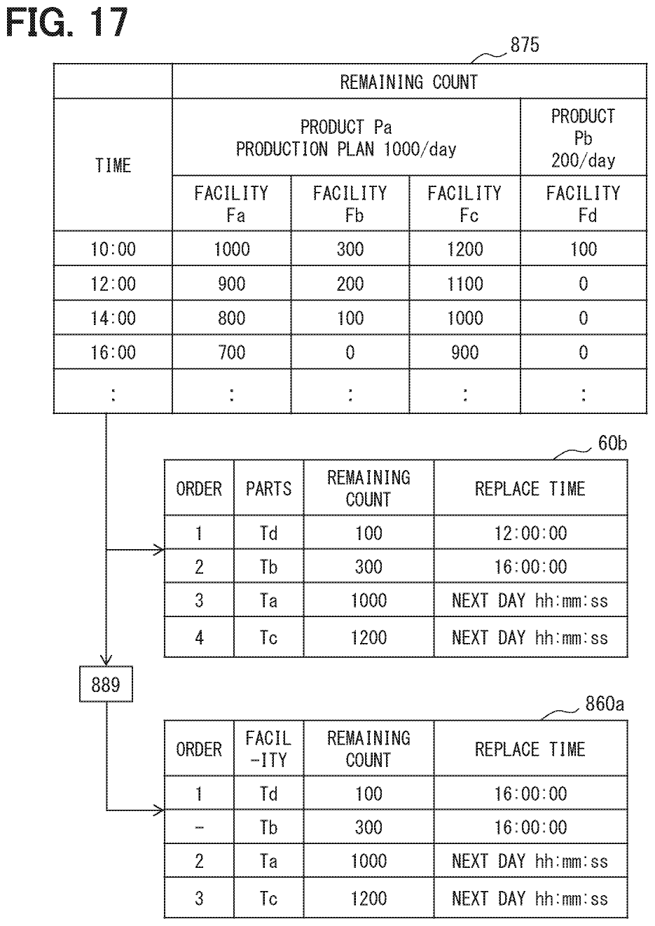

FIG. 17 shows a planing chart 875, which indicates the production plan for the product Pa (1,000 units/day) and the production plan for the product Pb (200 units/day), and the remaining count of the plurality of facilities Fa, Fb, Fc, and Fd. Furthermore, this drawing shows a display example of the replace support information 60b in the comparative example and a display example of the replace support information 860a in this embodiment.

It is assumed that the production plan quantity per day for the product Pa is 1000 units. It is assumed that the production plan quantity per day for the product Pb is 200 units. It is assumed that processing capacities of the facility Fa, Fb, Fc, and Fd are equal and processing quantity per hour is 50 units and processing quantity per two-hours is 100 units.

In the comparative example, all four pieces of the facilities Fa, Fb, Fc, and Fd are in operation. In this case, at 10:00, the replace support information 60b displayed on the display device 61 includes, the replacement time of 12:00:00 for the consumable part Td of the facility Fd, the replacement time of 16:00:00 for the consumable part Tb of the facility Fb, the replacement time of tomorrow hh:mm:ss for the consumable part Tb of the facility Fb, and the replacement time of tomorrow hh:mm:ss for the consumable part Tc of the facility Fc. The order for requiring the replacement is the order of Td, Tb, Ta, and Tc. Specifically, in the comparative example, workers are instructed to perform two replacements today.

On the other hand, in this embodiment, which proceeds via the step 889, the replacement plan is adjusted to minimize the number of replacements while satisfying the production plan, and the replace support information 860a is determined. In the step 889, the control device 30 adjusts a postponement of the replacement time (12:00:00) for the consumable part Td. In the example shown, the production plan for the product Pb can be met by restarting the facility Fd and using the consumable part Td after the replacet time 16:00:00 for the consumable part Tb. In other words, in the step 889, the control device 30 can determine that the production plan for the product Pb can be met even if the replacement time for the consumable part Td is postponed. In the step 889, the control device 30 adjusts a postponement of the replacement time which was set based on condition diagnosis of the consumable part 12. As a result, the worker can determine that it is possible to shut down the facility Fd and the facility Fb at the replacement time of 16:00:00 and then consecutively perform the replacements of the consumable part Td and the consumable part Tb on both facilities.

In this embodiment, the consumable part 12 is one of a plurality of consumable parts 12 corresponding to a number of a plurality of types of workpieces. The control device 30 is configured to adjust the replacement time. The control device 30 adjusts the replacement times so that the production plan stored in the production information storage unit 51 is satisfied and the replacement times for a plurality of the consumable parts are planned to approach one another. According to this embodiment, it is possible to minimize the number of replacements for a plurality of the consumable parts 12 while satisfying production plans and performing replacement operations efficiently.

### Ninth Embodiment

This embodiment is a modified embodiment of the preceding embodiment which is provided as a basic embodiment. In the above embodiment, the time at which the remaining count reaches zero (0) is set as the replacement time. Alternatively, in this embodiment, the replacement time is set to the time at which the remaining count reaches a value equal to or less than the allowed count.

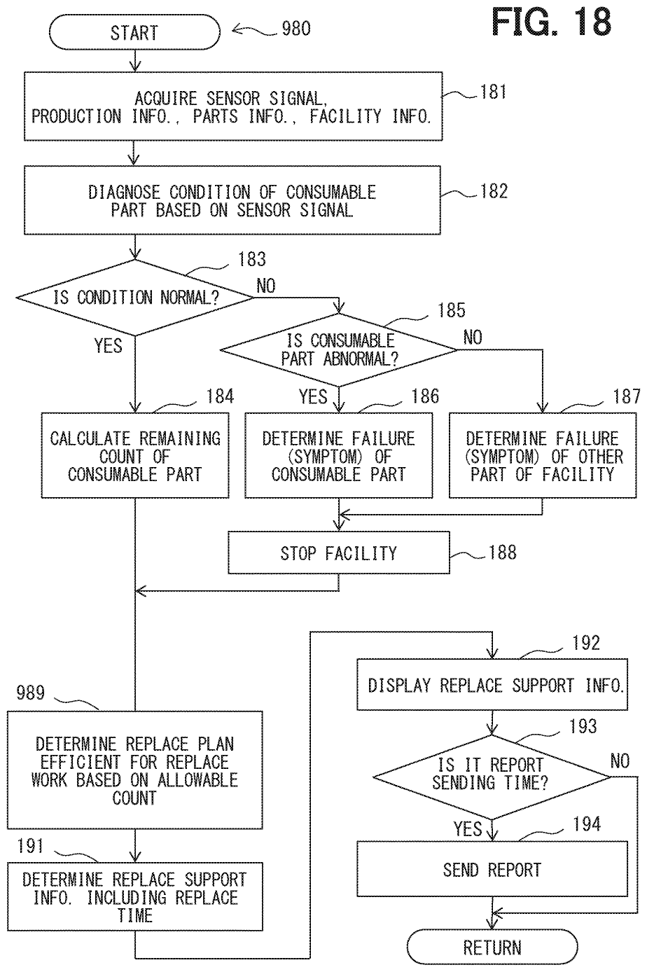

As shown in FIG. 18, process 980 includes step 989 instead of the step 889. In the step 989, the control unit 30 determines an efficient replacement plan based on the allowable count.

The allowable count may be determined based on the characteristics of the consumable part 12. The allowable count may be a value set in advance in the system 1. Furthermore, the allowable count may be set using a feedback method based on an actual record of the remaining count when the consumable part 12 is actually replaced.

The allowable count may be set by taking into account factors such as a cost for replacing the consumable part 12. The allowable count may be set based on a balance between the cost of the consumable part 12 and the cost of replacement. The cost of replacement may include the cost of dispatching worker and/or labor costs incurred during the replacement work. In the example shown in the drawing, it is assumed that the allowable count is 30.

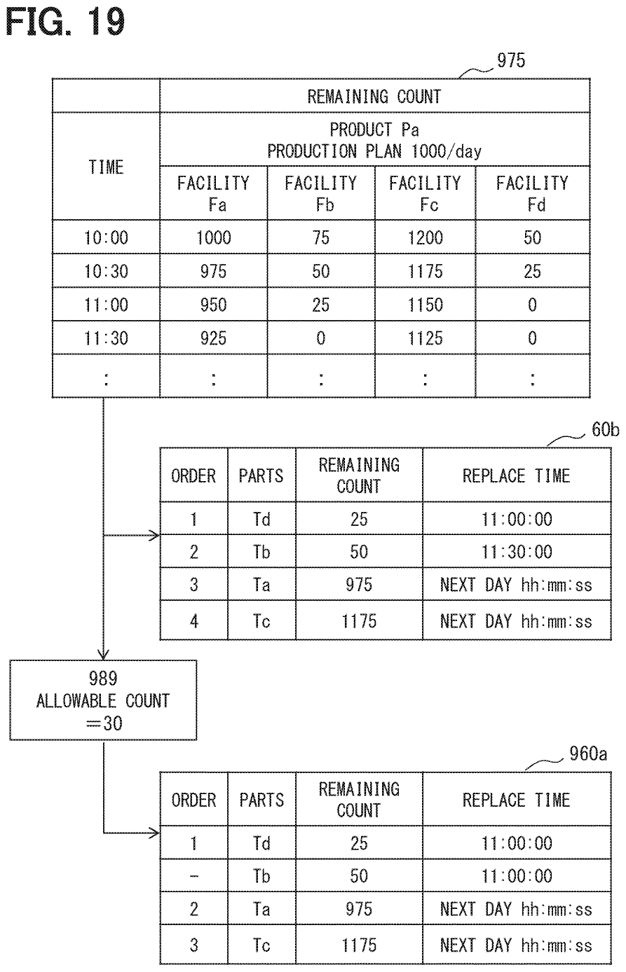

FIG. 19 shows a planing chart 975, which indicates the production plan for the product Pa (1,000 units/day) and the remaining count of the consumable part in the facility. Furthermore, this drawing shows a display example of the replace support information 60b in the comparative example and a display example of the replace support information 960a in this embodiment.

In the example shown, at 10:00, two replacement times are displayed. The first is the replacement time of 11:00:00, when the remaining count of the consumable part Td in the facility Fd reaches zero (0). The second is the replacement time of 11:30:00, when the remaining count of the consumable part Tb in the facility Fd reaches zero (0). Therefore, in the comparative example, the worker is required to enter both the replacement time of 11:00:00 and the replacement time of 11:30:00. However, performing replacement work on two different pieces of the facilities within 30 minutes is hardly efficient.

In contrast, in this embodiment, which proceeds via the step 989, the allowable count is set. In the above embodiment, when the remaining count of one consumable part reaches zero (0), a common replacement time is set if the remaining count of another consumable part is less than the allowable count. In the example shown in the drawing, since the remaining count for the consumable part Tb is less than the allowable count (25<30) at the replacement time 11:00 for the consumable part Td, the system allows for the simultaneous replace of the consumable parts Td and Tb at that time. In the example shown in the drawing, if the remaining counts for the plurality of consumable parts Tb and Td are less than the allowable count, the system sets the same replacement time 11:00:00 for the plurality of consumable parts Tb and Td. This allows the worker to perform the replacement of the consumable part Tb and the replacement of the consumable part Td consecutively. If the replacement of the consumable part 12 is permitted in the case that the remaining count is less than the allowable count, the replacement time is set so that a plurality of the consumable parts 12 may be replaced consecutively. For example, among the plurality of the replacement times, the earliest one is set as an acceptable one of common replacement time.

In this embodiment, the consumable part 12 is one of the plurality of the consumable parts Ta, Tb, Tc, and Td. The control device 30 is configured to set the same replacement time for one of the consumable part whose remaining count has fallen below a predetermined threshold as for other consumable parts. In the example shown in the drawing, the system sets the replacement time 11:00:00, which is the same for the other one of the consumable part Td, for one of the consumable part Tb of which the remaining count 25 reaches less than the allowable count 30 at the time 11:00. This allows the worker to perform the replacement work of the consumable part Tb and the replacement work of the consumable part Td consecutively.

### Tenth Embodiment

This embodiment is a modified embodiment of the preceding embodiment which is provided as a basic embodiment. In the above embodiment, when the remaining count of one consumable part reaches zero (0), a common replacement time is set if the remaining count of another consumable part is less than the allowable count. This allowable count may also be applied in the event that one of the consumable parts is a failure(or shows symptom of a failure).

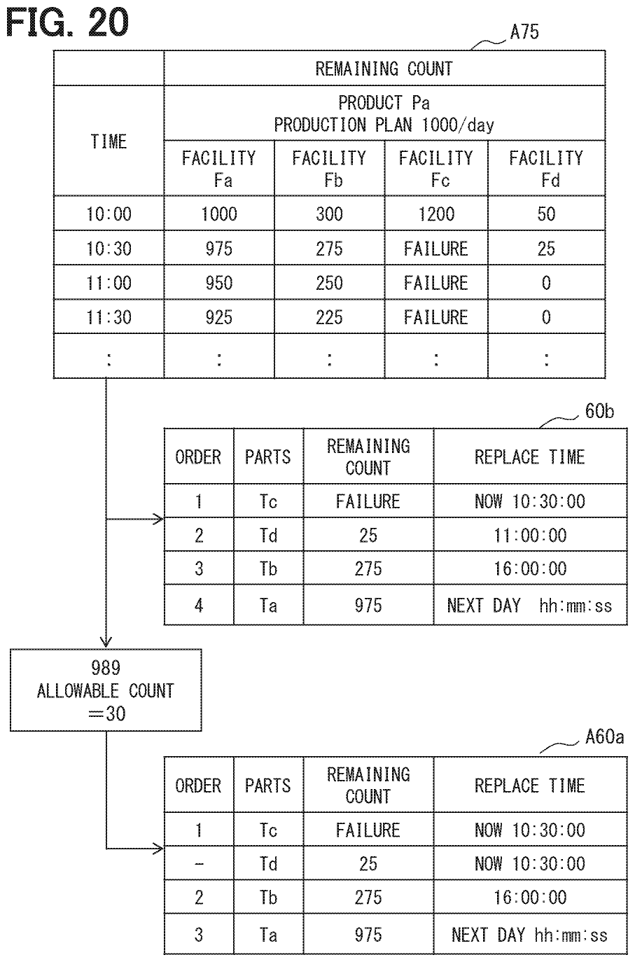

FIG. 20 shows a planing chart A75, which indicates the production plan for the product Pa (1000 units per day) and the remaining count. Furthermore, this drawing shows a display example of the replace support information 60b in the comparative example and a display example of the replace support information A60a in this embodiment. Here, a scenario is assumed that a failure occurs in the consumable part Tc of the facility Fc at the time of 10:30.

In the comparative example, at the time of 10:30, the current time is displayed as the replacement time for the consumable part Tc. Therefore, the workers are required to replace them immediately. Consecutively, the replacement of the consumable part Td for the facility Fd is required at the replacement time of 11:00:00. Therefore, in the comparative example, the worker is required to replace the consumable part Tc of the facility Fc and the consumable part Td of the facility Fd within a period of just 30 minutes. However, performing replacement work on two different pieces of the facilities within 30 minutes is hardly efficient.

In contrast, in this embodiment, which proceeds via the step 989, the allowable count is set. If a failure (or a symptom of a failure) occurs in one of the consumable part, and the remaining count of the other consumable part is less than the allowable count, a common replacement time is set. If the remaining count of the consumable part 12 is less than the allowable count, it is allowed to perform the replacement of the consumable part 12.

In this embodiment, the consumable part 12 is one of the plurality of the consumable parts Ta, Tb, Tc, and Td. The control device 30 is configured to set the same replacement time for one of the consumable part whose remaining count has fallen below a predetermined threshold as for other consumable parts. In the example shown in the drawing, the system sets the replacement time 10:30:00, which is the same for the other one of the consumable part Tc, for one of the consumable part Td of which the remaining count 25 reaches less than the allowable count 30 at the time 10:30. This allows the worker to perform the replacement work of the consumable part Tc and the replacement work of the consumable part Td consecutively.

### Eleventh Embodiment

This embodiment is a modified embodiment of the preceding embodiment which is provided as a basic embodiment. In the above embodiment, the consumable part 12 is replaced if the remaining count reaches zero (0), thereby completing its service life as the consumable part 12. The consumable part 12 that have reached the end of their service life is either discarded or reused as raw materials. Such consumable part 12 is referred to as the one-time type consumable part. On the other hand, the consumable part 12 includes consumable parts that are reused when the remaining count reaches zero (0) or when the remaining count falls below the allowable count. Such a consumable part 12 is referred to as a reusable type consumable part. In this embodiment, the remaining count for the one-time type consumable part and the remaining count for reusable type consumable part are set.

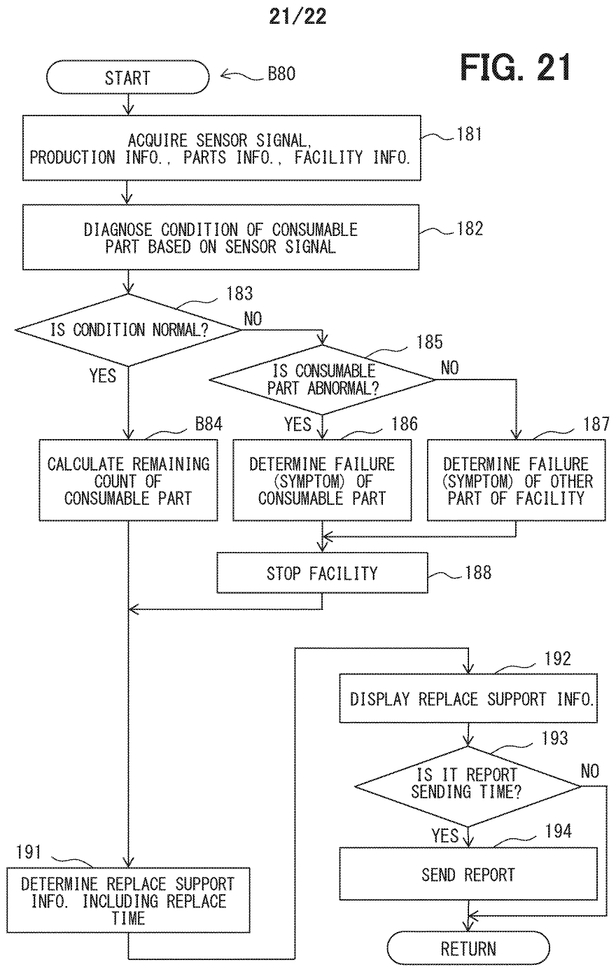

As shown in FIG. 21, process B80 includes step B84 instead of the step 184. In the step B84, the control unit 30 calculates the remaining count based on whether the consumable part 12 is the one-time type or the reusable type.

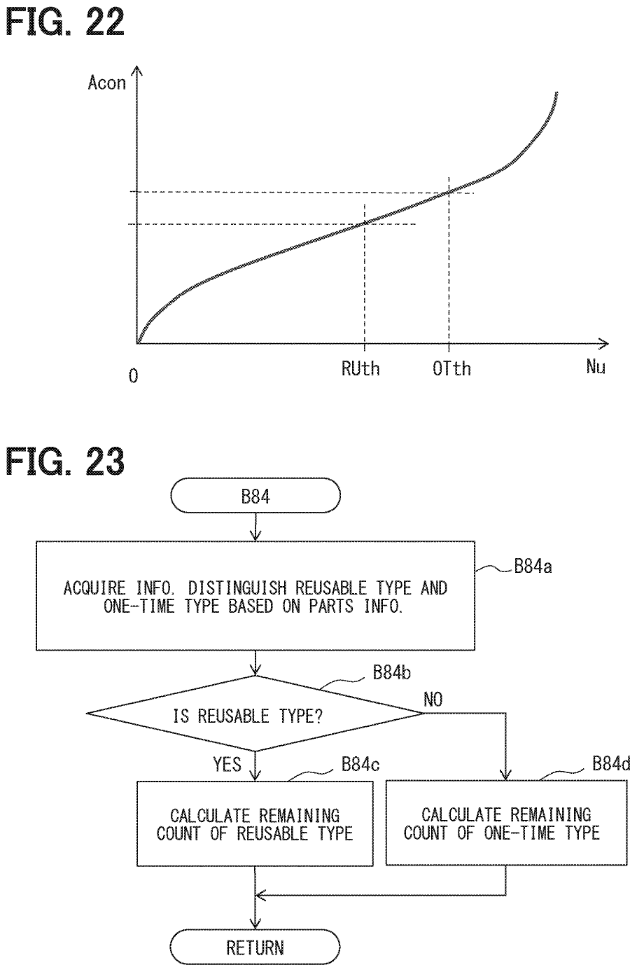

FIG. 22 is a graph showing a relationship between an upper limit of a usable frequency of a consumable part 12 and a wearing condition. The horizontal axis represents the use count Nu. The vertical axis represents the consumption amount (Acon), which corresponds to condition of wearing amount. As shown in the drawings, during the initial period of use of the consumable part 12, the consumption amount Acon increases rapidly. Thereafter, the consumption amount (Acon) increases gradually and proportionally with the use count (Nu). Eventually, toward the end of the service life of the consumable part 12, the consumption amount Acon increases sharply as the use count Nu increases.

The reusable consumable part 12 achieves an overall longer service life as components through reuse. On the other hand, the reusable consumable part 12 have a limited number of reuses. In the case that a cutting tool is assumed as an example of the consumable parts 12, the cutting tool may be restored to a reusable condition through a regeneration process including a regrinding step. In addition, an amount of regrinding is limited to increase the number of times of reuse. For these reasons, the consumable part 12 of the reuse type has a relatively low number of usable count (RUth) per one usage cycle. On the other hand, since the one-time type consumable part 12 do not need to be reused, it has a relatively higher count of the use count (OTth). Generally, the usable count (RUth) is fewer than a number of usable count (OTth). The usable counts RUth and OTth provide the initial usable counts to calculate the remaining count of the consumable part 12.

Returning to FIG. 21, in the step B84, if the consumable part 12 is the reusable type, the remaining count calculated based on the maximum one of the usable count (RUth). In the step B84, if the consumable part 12 is a one-time type, the remaining count based on the maximum one of the usable count (OTth).

FIG. 23 is a flowchart showing details of the step B84. In the step B84a, the control unit 30 retrieves identification information from the part information storage unit 52 to distinguish between the reusable type and the one-time type. The identification information includes data indicating whether the consumable part 12 used in the facility 10 is the reusable type or the one-time type.

In the step B84b, the control unit 30 determines whether the consumable part 12, which was determined to be in good condition in the step 183, is the reusable type or not. If the consumable part 12 is the reusable type, the process branches to YES and proceeds to the step B84c. If the consumable part 12 is not the reusable type, the process branches to NO and proceeds to the step B84d. That is, if the consumable part 12 is the one-time type, the process branches to NO and proceeds to the step B84d.

In the step B84c, the control unit 30 calculates the remaining count of uses for the reusable type consumable part. In the step B84c, the control unit 30 calculates the remaining count for the consumable part 12, assuming that a use from the usable count RUth in which it is usable as a reusable type.

In the step B84d, the control unit 30 calculates the remaining count of uses for the one-time type consumable part. In the step B84d, the control unit 30 calculates the remaining count of uses for the consumable part 12, assuming that a use from the use count OTth in which it is usable as a one-time type.

In this embodiment, the control unit 30 is configured to generate different remaining counts depending on whether the consumable part is the reusable type or the one-time type, based on the classification information stored in the part information storage unit 52. It is possible to provide appropriate replace support information based on whether the consumable part 12 is the reusable type or the consumable part 12 is the one-time type. The replace support information includes the remaining counts of uses, depending on whether the consumable part 12 is the reusable type or the consumable part 12 is the one-time type. As a result, workers can efficiently replace parts depending on whether they are the reusable type or the one-time type.

### Other Embodiments

The disclosure in this specification, the drawings, and the like is not limited to the exemplified embodiments. The disclosure includes the illustrated embodiments and variations thereof by those skilled in the art. For example, the present disclosure is not limited to the combinations of components and/or elements shown in the embodiments. The disclosure may be provided in various combinations. The disclosure may include additional portions that can be added to the embodiments. The disclosure includes those in which the components and/or elements of the embodiments are omitted. The disclosure includes the replacement or combination of components and/or elements between one embodiment and another embodiment. The disclosed technical scope is not limited to the descriptions of the embodiments. It should be understood that part of disclosed technical scope is indicated by recitation of claims, and includes every modification within the equivalent meaning and the recitation of the scope of claims.

The disclosure in the specification, drawings and the like is not limited by the description of the claims. The disclosures in the description, the drawings, and the like encompass the technical ideas described in the claims, and further extend to a wider variety of technical ideas than those in the claims. Thus, various technical ideas can be extracted from the disclosure of the specification, the drawings and the like without being limited to the description of the present disclosure.

For example, each of the embodiments described above has different characteristics. These different features can be combined with one another. For example, the ninth and tenth embodiments, which determine a permissible number of occurrences, can be applied in addition to all other embodiments.

### Disclosure of Technical Concept

This specification discloses a plurality of technical ideas described in the following enumerated items. Some of the items may be described in a multiple dependent form, in which a preceding item is alternatively referenced in subsequent items. Furthermore, some of the items may be described in a multiple dependent form that refers to another item in a multiple dependent form. These items described in multiple dependent form define a plurality of technical ideas.

(Technical Concept 1) A system comprising: a consumable part (12) installed in a facility that is subject to wear; a sensor (11) for detecting physical quantity that change in relation to the wear of the consumable parts; a control device (30), including at least one of (i) a circuit and (ii) a processor with a memory storing computer program code executable by the processor, the at least one of the circuit and the processor configured to generate replace support information (60a, 260a, 360a, 660a, 760a, 860a,960a, A60a) including a remaining count for the consumable part and a replacement time at which the consumable part is required to be replaced based on the physical quantity detected by the sensor; and a display device (61) for displaying the replace support information.

(Technical Concept 2) The system according to Technical Concept 1, wherein the consumable part is a part installed in a facility used to process workpieces, and is a consumable part that wear out in proportion to a number of times the workpieces are processed, wherein the remaining quantity is a remaining count for which the consumable part is usable to the workpiece.

(Technical Concept 3) The system according to Technical Concept 1 or 2, further comprising: a part information storage unit (52) that stores part information, including quality information indicating a quality of the consumable part, wherein the control device is configured to determine a replace plan such that, based on the quality information stored in the part information storage unit, one consumable part is replaced with a consumable part of relatively higher quality, and another consumable part is replaced with a consumable part of relatively lower quality.

(Technical Concept 4) The system according to any one of Technical Concepts 1-3, wherein the consumable part is one of consumable parts used sequentially on a single workpiece, further comprising: a production information storage unit (51) that stores production information containing process information indicating an order of use of the plurality of the consumable parts, wherein the control device is configured to adjust the remaining quantity and the replacement time based on the process information.

(Technical Concept 5) The system according to any one of Technical Concepts 1-3, further comprising: a production information storage unit (51) that stores information including a production plan indicating a number of process of workpieces, wherein the consumable part is one of a plurality of consumable parts that can be selectively used for a single workpiece, and wherein the control device is configured to adjust a distribution of workpieces to the plurality of the consumable parts so as to satisfy the production plan stored in the production information storage unit and to ensure that a plurality of replacement times for the plurality of the consumable parts approach one another.

(Technical Concept 6) The system according to any one of Technical Concepts 1-5, further comprising: a production information storage unit (51) that stores information including a production plan indicating a number of workpieces to be processed, wherein a number of process for each of a plurality of types of workpieces, wherein the consumable part is one of a plurality of consumable parts corresponding to the number of the plurality of types, and wherein the control device is configured to adjust a plurality of replacement times so that the production plan stored in the production information storage unit is satisfied and so that the plurality of replacement times for the plurality of the consumable parts approach one another.

(Technical Concept 7) The system according to any one of Technical Concepts 1-6, wherein the consumable part is one of a plurality of consumable parts, and wherein the control device is configured to set a replacement time, which is the same as the other consumable part, for a consumable part whose remaining quantity is below a predetermined threshold.

(Technical Concept 8) The system according to any one of Technical Concepts 1-7, further comprising: a part information storage unit (52) that stores part information containing classification information indicating whether the consumable part is a reusable type or a one-time type, wherein the control device is configured to generate different remaining quantities depending on whether the consumable part is of the reusable type or the consumable part is of the one-time type, based on the classification information stored in the part information storage unit.

(Technical Concept 9) The system according to any one of Technical Concepts 1-8, further comprising: an output device for sharing information among the plurality of entities that make up a supply chain, wherein the control device is configured to share information related to replacement of the consumable part among the plurality of entities.

(Technical Concept 10) A method of part management, executed by a control device (30) comprising at least one processor, the method comprising the steps of: acquiring physical quantity that change in relation to wear from a consumable part (12); generating replace support information (60a, 260a, 360a, 660a, 760a, 860a,960a, A60a) including a remaining count for the consumable part and a replacement time at which the consumable part is required to be replaced based on the physical quantity detected by a sensor; and displaying the replace support information on a display device (61).

(Technical Idea 11) A non-transitory computer-readable medium storing thereon program instructions that, when executed by a processor, cause the processor to perform a method comprising: acquiring physical quantity that change in relation to wear from a consumable part (12); generating replace support information (60a, 260a, 360a, 660a, 760a, 860a,960a, A60a) including a remaining count for the consumable part and a replacement time at which the consumable part is required to be replaced based on the physical quantity detected by a sensor; and
displaying the replace support information on a display device (61).

Each of a plurality of technical concepts described in this specification may be understood as a system, a method, a program, or a storage medium for storing a program.

What is claimed is:

1. A system comprising:
a consumable part installed in a facility that is subject to wear;
a sensor that detects a physical quantity that change in relation to wear of the consumable part;
a control device, including at least one of (i) a circuit and (ii) a processor with a memory storing computer program code executable by the processor, the at least one of the circuit and the processor configured to generate replace support information including a remaining quantity for the consumable part and a replacement time at which the consumable part is required to be replaced based on the physical quantity detected by the sensor; and
a display device for displaying the replace support information.

2. The system according to claim 1, wherein
the consumable part is a part installed in a facility used to process workpieces, and is a consumable part that wear out in proportion to a number of times the workpieces are processed, and wherein
the remaining quantity is a remaining count for which the consumable part is usable to the workpiece.

3. The system according to claim 1, further comprising:
a part information storage unit that stores part information, including quality information indicating a quality of the consumable part, wherein
the control device is configured to determine a replace plan such that, based on the quality information stored in the part information storage unit, one consumable part is replaced with a consumable part of relatively higher quality, and another consumable part is replaced with a consumable part of relatively lower quality.

4. The system according to claim 1, wherein
the consumable part is one of a plurality of consumable parts that are used sequentially on a single workpiece, further comprising:
a production information storage unit that stores production information including process information indicating an order of use of the plurality of the consumable parts, wherein
the control device is configured to adjust the remaining quantity and the replacement time based on the process information.

5. The system according to claim 1, further comprising:
a production information storage unit that stores information including a production plan indicating a number of process of workpieces, wherein
the consumable part is one of a plurality of consumable parts that can be selectively used for a single workpiece, and wherein
the control device is configured to adjust a distribution of workpieces to the plurality of the consumable parts so as to satisfy the production plan stored in the production information storage unit and to ensure that a plurality of replacement times for the plurality of the consumable parts approach one another.

6. The system according to claim 1, further comprising:
a production information storage unit that stores information including a production plan indicating a number of workpieces to be processed, wherein a number of process for each of a plurality of types of workpieces, wherein
the consumable part is one of a plurality of consumable parts corresponding to the number of the plurality of types, and wherein
the control device is configured to adjust a plurality of replacement times so that the production plan stored in the production information storage unit is satisfied and so that the plurality of replacement times for the plurality of the consumable parts approach one another.

7. The system according to claim 1, wherein
the consumable part is one of a plurality of consumable parts, and wherein
the control device is configured to set a replacement time, which is the same as the other consumable part, for a consumable part whose remaining quantity is below a predetermined threshold.

8. The system according to claim 1, further comprising:
a part information storage unit that stores part information containing classification information indicating whether the consumable part is a reusable type or a one-time type, wherein
the control device is configured to generate different remaining quantities depending on whether the consumable part is of the reusable type or the consumable part is of the one-time type, based on the classification information stored in the part information storage unit.

9. The system according to claim 1, further comprising:
an output device for sharing information among a plurality of entities that make up a supply chain, wherein
the control device is configured to share information related to replacement of the consumable part among the plurality of entities.

10. A method of part management, executed by a control device comprising at least one processor, the method comprising the steps of:
acquiring physical quantity that change in relation to wear from a consumable part;
generating replace support information including a remaining count for the consumable part and a replacement time at which the consumable part is required to be replaced based on the physical quantity detected by a sensor; and
displaying the replace support information on a display device.

11. A non-transitory computer-readable medium storing thereon program instructions that, when executed by a processor, cause the processor to perform a method comprising:
acquiring physical quantity that change in relation to wear from a consumable part;
generating replace support information including a remaining count for the consumable part and a replacement time at which the consumable part is required to be replaced based on the physical quantity detected by a sensor; and
displaying the replace support information on a display device.
